(19) United States
(12) Patent Application Publication
(10) Pub. No.: US 2018/0115551 A1
(43) Pub. Date: Apr. 26, 2018

(54) PROXY SYSTEM FOR SECURELY PROVISIONING COMPUTING RESOURCES IN CLOUD COMPUTING ENVIRONMENT

(71) Applicant: Brian Cole, Castle Hill (AU)

(72) Inventor: Brian Cole, Castle Hill (AU)

(21) Appl. No.: 15/609,737

(22) Filed: May 31, 2017

Related U.S. Application Data
(60) Provisional application No. 62/410,609, filed on Oct. 20, 2016.

(51) Int. Cl. H04L 29/06; H04L 12/911; H04L 12/24

(52) U.S. Cl. CPC H04L 63/10; H04L 47/783; H04L 63/102; H04L 47/70; H04L 41/28

(57) ABSTRACT

A computer process includes, but is not limited to, obtaining cloud credential data for accessing one or more cloud accounts of a cloud computing system having one or more computing resources available for provisioning to one or more client machines; establishing at least one proxy account associated with the one or more cloud accounts of the cloud computing system, the at least one proxy account including at least proxy credential data and access to at least one provisioning policy, the at least one provisioning policy including one or more provisioning constraints with respect to provisioning the one or more computing resources which one or more provisioning constraints are not present in the one or more cloud accounts; and applying the one or more provisioning constraints of the at least one provisioning policy with respect to all provisioning requests of the one or more client machines that originate via the at least one proxy account to limit provisioning of the one or more computing resources that would otherwise be available from the cloud computing system via the one or more cloud accounts.

### PRIORITY CLAIM

This application claims the benefit of and/or priority to U.S. provisional patent application Ser. No. 62/410,609 filed Oct. 20, 2016. The foregoing application is incorporated by reference in its entirety as if fully set forth herein.

### FIELD OF THE INVENTION

Embodiments of the invention relate generally to data security, and more specifically, to a proxy system for provisioning computing resources in a cloud computing environment.

### BACKGROUND

The providers of cloud computing systems offer businesses a flexible outsourcing option for computational resources. Cloud providers deliver resources such as hardware systems, virtual machines, storage, internet connectivity and software applications to customers from large pools of multi-tenant computing resources.

By their nature, cloud computing systems are hosted remotely to their customers, and customers do not have physical access to the infrastructure. This contrasts with previous systems which were hosted on-premise or in a dedicated data center.

Systems hosted on premise or in a dedicated data center require that the customer's administrators have direct access to the system's infrastructure. Along with this direct access to the infrastructure, these administrators are given root access, and various administrator accounts, which allows broad access to the underlying operating system and effectively gives these individuals the ability to install arbitrary applications and access low-level constructs such as files.

If an administrator has direct access to infrastructure, there is little reason to restrict access via a root account, as this level of access could also be obtained using their access to the infrastructure. Therefore, providing the same individuals with root access provides no additional security concerns.

For convenience, it is common for additional individuals to also be given root access, since providing the same level of trust to additional individuals provides no additional security concerns.

Therefore, various individuals can still install arbitrary applications and access low-level constructs such as files.

For example, consider an organization which is a customer of a cloud computing system. This organization currently trusts its administrators with root or administration accounts to the cloud computing system. These accounts are required to provisioning resources into the cloud computing system, which is needed by the organization from time-to-time. Organizations will typically have rules for administrators, detailing the organization's policies for deploying resources to the cloud computing system. For example, there might be a requirement that resource provisioning requests are properly authorized. However, the root or administration account gives the individuals with access the ability to provisioning resources with no regard to these organizational requirements, and administrators can provision arbitrary resources using the cloud accounts, with potential for accidental or deliberate compromise of data.

As another example, consider the challenges of performing secure multi-party computation. Providing an environment which is secure, yet shared, is generally considered to require a trusted third-party to administer the environment, who will be trusted to install the resources needed for the computation, as agreed by all parties, but is trusted not to install any resources that will compromise the security of the environment. Finding a trusted third party is not always possible. Even if a trusted third-party can be found, they will still be assumed to have installed resources exactly as agreed by all parties, and not change them later, either by accident or misuse. Additionally, the third-party will have access to the data that all parties wish to remain private, since the administrator accounts which are required to provisioning and maintain the environment could be used to access data directly or indirectly.

Accordingly, while desirable results have been achieved in the art, there exists much room for improvement.

### SUMMARY

In some embodiments, a system allows the removal of root access and other administration accounts and provides an alternative means of administrating cloud computing systems. By forcing administration through a proxy, the policies defined in the proxy are enforced on requests for updates to the cloud computing environment, enabling greater data security. For secure multi-party computation, the combination of a cloud computing environment and embodiments disclosed herein provides a greater level of security, in that parties can be assured that the resources are installed as agreed, no additional resources are installed, and/or no third party can obtain access to the private data.

In one embodiment, a computer process for interacting with a cloud computing system having one or more computing resources available for provisioning to one or more client machines to increase data security includes, but is not limited to, obtaining cloud credential data for accessing one or more cloud accounts of a cloud computing system having one or more computing resources available for provisioning to one or more client machines; establishing at least one proxy account associated with the one or more cloud accounts of the cloud computing system, the at least one proxy account including at least proxy credential data and access to at least one provisioning policy, the at least one provisioning policy including one or more provisioning constraints with respect to provisioning the one or more computing resources which one or more provisioning constraints are not present in the one or more cloud accounts; and applying the one or more provisioning constraints of the at least one provisioning policy with respect to all provisioning requests of the one or more client machines that originate via the at least one proxy account to limit provisioning of the one or more computing resources that would otherwise be available from the cloud computing system via the one or more cloud accounts.

In another embodiment, a computer process for interacting with a cloud computing system having one or more computing resources available for provisioning to one or more client machines to increase data security includes, but is not limited to, receiving at least one request via at least one proxy account to provision one or more computing resources of a cloud computing system; determining whether provisioning of the one or more computing resources of the cloud computing system is permitted by at least one provisioning policy associated with the at least one proxy account, the provisioning policy including one or more provisioning constraints with respect to provisioning the one or more computing resources which one or more provisioning constraints are not imposed by the cloud computing system; and denying the at least one request to provision the one or more computing resources of the one or more cloud accounts in response to a determination that the at least one provisioning policy associated with the at least one proxy account does not permit provisioning of the one or more computing resources.

In a further embodiment, a system that increases security of data in a cloud computing environment includes a cloud computing system having one or more computing resources available for provisioning to one or more client machines via one or more cloud accounts; and a proxy computing system that is communicably linked to the cloud computing system, the proxy computing system including memory bearing one or more computer executable instructions; and at least one processing device operably coupled to the memory and configured to implement the one or more computer executable instructions to perform operations including, but not limited to, establishing at least one proxy account associated with the one or more cloud accounts of the cloud computing system, the at least one proxy account including at least proxy credential data and access to at least one provisioning policy, the at least one provisioning policy including one or more provisioning constraints with respect to provisioning the one or more computing resources which one or more provisioning constraints are not present in the one or more cloud accounts; and applying the one or more provisioning constraints of the at least one provisioning policy with respect to all provisioning requests of the one or more client machines that originate via the at least one proxy account to limit provisioning of the one or more computing resources of the one or more cloud accounts that would otherwise be available from the cloud computing system.

### BRIEF DESCRIPTION OF THE DRAWINGS

Embodiments of the present invention are described in detail below with reference to the following drawings:

FIGS. 1A and 1B and 1C are system diagrams, in accordance with embodiments of the invention;

FIG. 2 is a system diagram, in accordance with an embodiment of the invention; and

FIGS. 3-12 are flow diagrams of a computer processes, in accordance with various embodiments of the invention.

### DETAILED DESCRIPTION

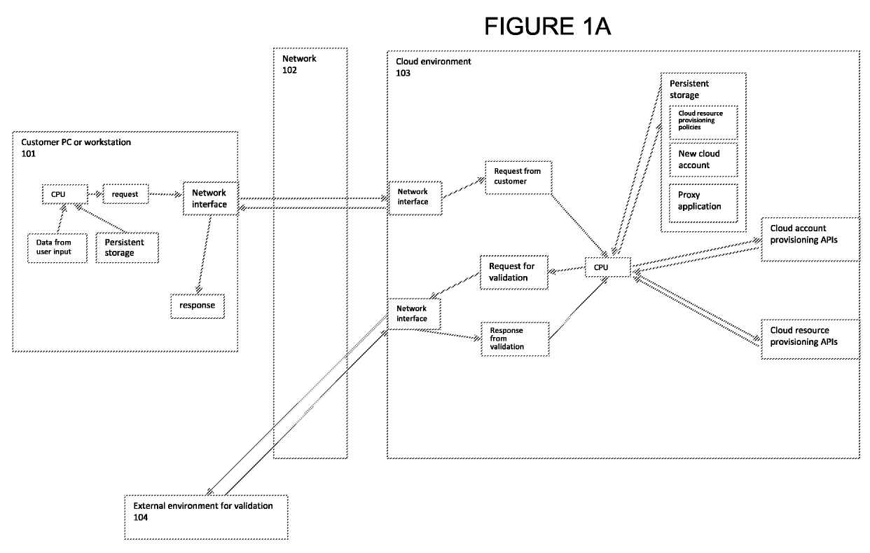

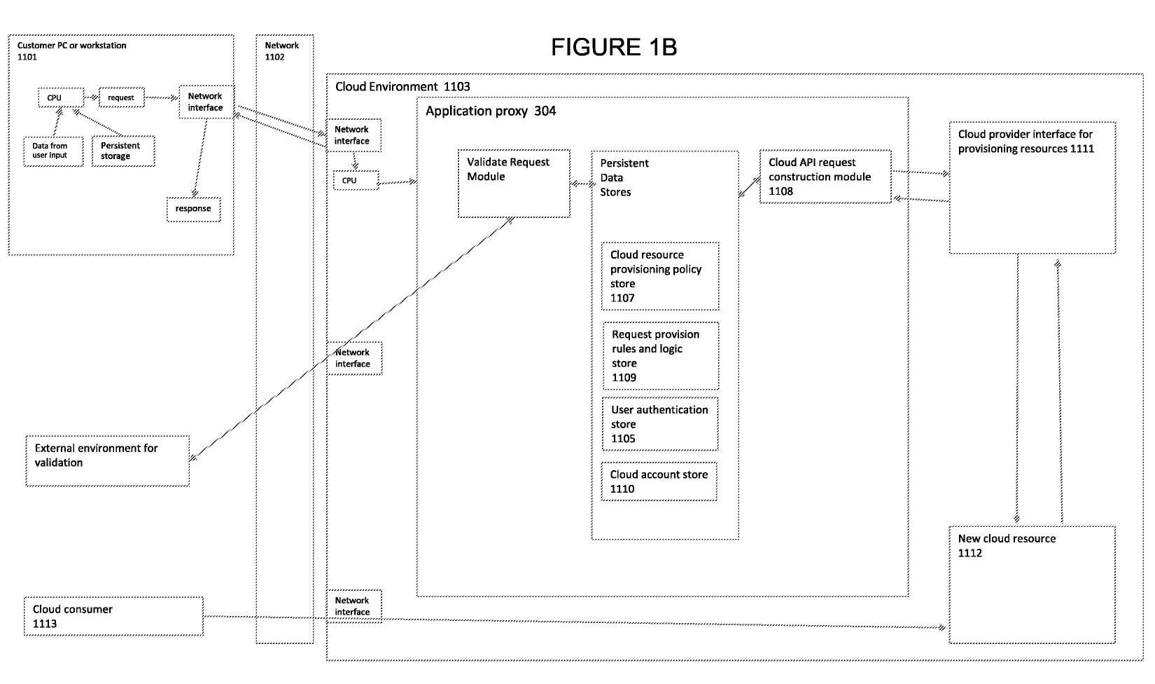

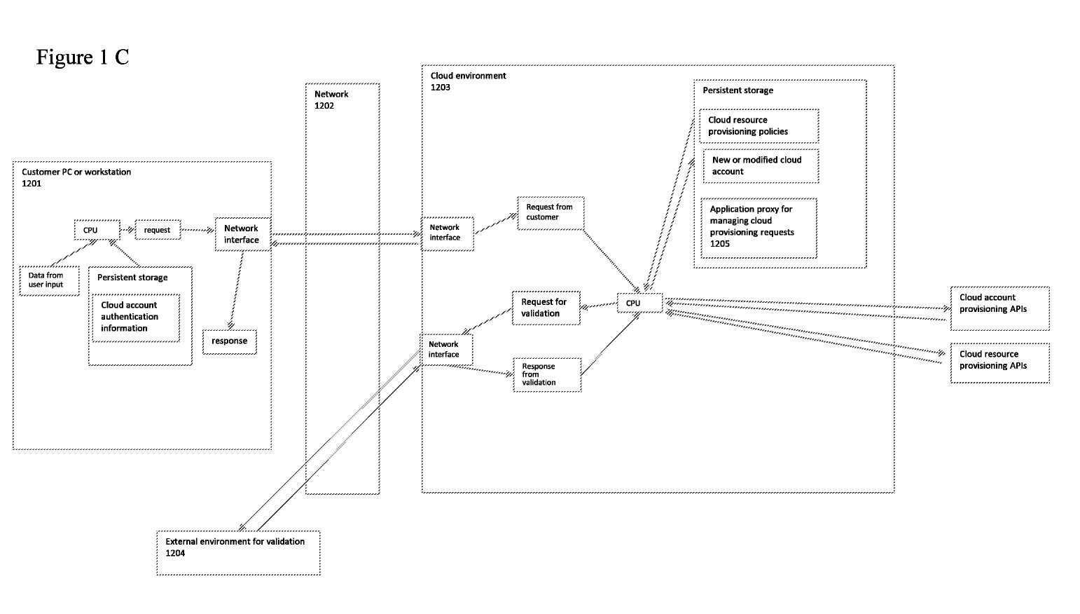

Specific details of certain embodiments of the invention are set forth in the following description and in FIGS. 1-12 to provide a thorough understanding of such embodiments. The present invention may have additional embodiments, may be practiced without one or more of the details described for any particular described embodiment, or may have any detail described for one particular embodiment practiced with any other detail described for another embodiment.

FIG. 1A is a system diagram, in accordance with an embodiment of the invention.

A customer's PC or workstation (101) constructs a request for a cloud subscription. Using information entered by a user, combined with information from persistent storage, a CPU executes instructions to construct a request. This request may include payment information for the subscription, information to authenticate a user for subsequent requests, and a set of cloud resource provisioning policies. The request is submitted to a network interface, which submits the request over a network (102) such as the internet, using the appropriate protocols such as HTTP/s, TCP/IP, with features such as encryption, routing, redundancy, and authentication provided by these protocols or additional protocols. The request is routed appropriately through routers, proxies, and firewalls, and is received by the network interface of a cloud provider (103)

A CPU on the cloud provider processes the subscription request. It uses information from the request and persistent data stores to construct and submit requests to validate information against internal data stores and external environments (104) as required. If the subscription request passes the validation, the CPU writes information to persistent data stores on the cloud provider, to create the required artifacts that will support subsequent requests to the cloud provider to provision resources in the environment. These artifacts are written to persistent storage.

An artifact written to persistent storage may be details of the subscription

An artifact written to persistent storage may be a user account which will be used to authenticate subsequent requests to the cloud provider as belonging to this subscription

An artifact written to persistent storage may be a set of cloud resource provisioning policies

An artifact written to persistent storage may be a new cloud account which can be used for authentication with a cloud resource provisioning API provided by the cloud provider. Details of the cloud account may be obtained by requesting details from a cloud account provisioning API.

A proxy application on the cloud provider associates these artifacts and processes subsequent requests. This proxy application is provisioned into the cloud environment, with application code and data written to persistent storage and associating the proxy application with a URI or resource address, so that subsequent requests related to this cloud subscription are directed to the proxy application for processing. The proxy application may contain such modules as an access control and security module, a request validation module, and a cloud API request construction module.

The artifacts and proxy application may be provisioned using calls to the cloud resource provisioning APIs.

A response containing information useful for subsequent requests may be returned to the customer's PC or workstation.

The Customer PC or workstation 101 may include a server, desktop, laptop, mobile device, wearable device, smartphone, tablet, node, or the like. The network 102 may be a local area network, wide area network, internet, private network, public network, wireless network, wired network, or the like. The cloud environment 103 can be a single server or computing device or a plurality of computing devices, which may or may not be distributed across disparate physical locations and/or physical units. [0032] FIG. 1B is a system diagram, in accordance with an embodiment of the invention.

A remote PC or workstation at a cloud customer 1101 constructs a request to provision a cloud resource. Using information entered by a user, combined with information from persistent and non-persistent storage, a CPU executes instructions to construct a request. This request may include information to authenticate a user and a description of the cloud resource to be provisioned. The request is submitted to a network interface, which submits the request over a network such as the internet 1102, using the appropriate protocols such as HTTP/s, TCP/IP, with features such as encryption, routing, redundancy, and authentication provided by these protocols or additional protocols. The request is routed appropriately through routers, proxies, and firewalls, and is received by the network interface of a cloud provider.

A CPU on the cloud provider 1103 processes the request from the cloud customer. The CPU reads code from persistent storage to run an application proxy 1104.

The application proxy uses information in the request from the cloud customer and persistent data stores to construct and submit requests to validate information against internal and external data stores as required.

Validation can include authentication of the user information in the request by an access control and security module 1104, which uses a user authentication store 1105 in persistent storage, which may be provided by an identity management system or similar, to determine and authenticate the user's identity.

Validation can include validation of the resource provisioning request by a request validation module 1106 which examines the request against the cloud resource provisioning policies, which are stored in a cloud resource provisioning policy store 1107 in persistent storage.

If the request is valid, the application proxy uses a cloud API request construction module 1108, to construct a request to the cloud resource provisioning API 1111. The request is constructed using rules and logic from persistent storage 1109 and includes a cloud account 1110 retrieved from persistent storage to authenticate the request to the cloud resource provisioning API.

The request is submitted to the cloud resource provisioning API 1111, which creates the requested cloud resource 1112 in the cloud environment. This resource may now be accessible to cloud consumers 1113 over the network.

A response containing information regarding the success of the request may be returned to the requesting remote PC or workstation.

FIG. 1C is a system diagram, in accordance with an embodiment of the invention.

A cloud subscription exists for a cloud environment. The cloud environment may have various applications provisioned, which may include one more application databases, SaaS applications, serverless applications, web applications, batch applications and similar artifacts which are created in a cloud environment. The cloud subscription may have one or more cloud accounts, which can be used to provision artifacts to the cloud environment.

A customer's PC or workstation (1201) constructs a request for an application proxy for managing cloud provisioning requests (1205, “the proxy”) to be provisioned into the cloud environment. Using information entered by a user, combined with information from persistent storage, a CPU executes instructions to construct a request. This request may include information to authenticate the user against a cloud account as a subscriber for this cloud subscription and authorized for this request, user information to authenticate the user to the application proxy for subsequent requests, and a set of cloud resource provisioning policies. The request is submitted to a network interface, which submits the request over a network (1202) such as the internet, using the appropriate protocols such as HTTP/s, TCP/IP, with features such as encryption, routing, redundancy, and authentication provided by these protocols or additional protocols. The request is routed appropriately through routers, proxies, and firewalls, and is received by the network interface of a cloud provider (1203).

A CPU on the cloud provider processes the request. It uses information from the request and persistent data stores to construct and submit requests to validate information against internal data stores and external environments (1204) as required. If the request passes the validation, the CPU writes information to persistent data stores on the cloud provider, to create the required artifacts that will support subsequent requests to the cloud provider to provision resources in the environment. These artifacts are written to persistent storage.

An artifact written to persistent storage may be details of the subscription.

An artifact written to persistent storage may be a user account which will be used to authenticate subsequent requests to the cloud provider as belonging to this subscription.

An artifact written to persistent storage may be a set of cloud resource provisioning policies.

Existing cloud accounts which could be used for authentication with a cloud resource provisioning API provided by the cloud provider are invalidated. This invalidation may occur by requesting account invalidation from a cloud account provisioning API.

An artifact written to persistent storage may be a new cloud account which can be used for authentication of subsequent requests by the proxy to the cloud resource provisioning API provided by the cloud provider. Details of the cloud account may be obtained by requesting details from a cloud account provisioning API.

An artifact written to persistent storage may be new authentication information for an existing cloud account which can be used for authentication of subsequent requests by the application proxy to the cloud resource provisioning API provided by the cloud provider. Details of the new authentication information for the existing cloud account may be obtained by requesting details from a cloud account provisioning API.

The proxy on the cloud provider associates these artifacts and processes subsequent requests. This proxy is provisioned into the cloud environment, with application code and data written to persistent storage and associating the proxy application with a URI or resource address, so that subsequent requests related to this cloud subscription are directed to the proxy application for processing. The proxy may contain such modules as an access control and security module, a request validation module, and a cloud API request construction module.

The artifacts and proxy application may be provisioned using calls to the cloud resource provisioning APIs.

A response containing information useful for subsequent requests may be returned to the customer's PC or workstation.

The Customer PC or workstation 1201 may include a server, desktop, laptop, mobile device, wearable device, smartphone, tablet, node, or the like. The network 1202 may be a local area network, wide area network, internet, private network, public network, wireless network, wired network, or the like. The cloud environment 1203 can be a single server or computing device or a plurality of computing devices, which may or may not be distributed across disparate physical locations and/or physical units.

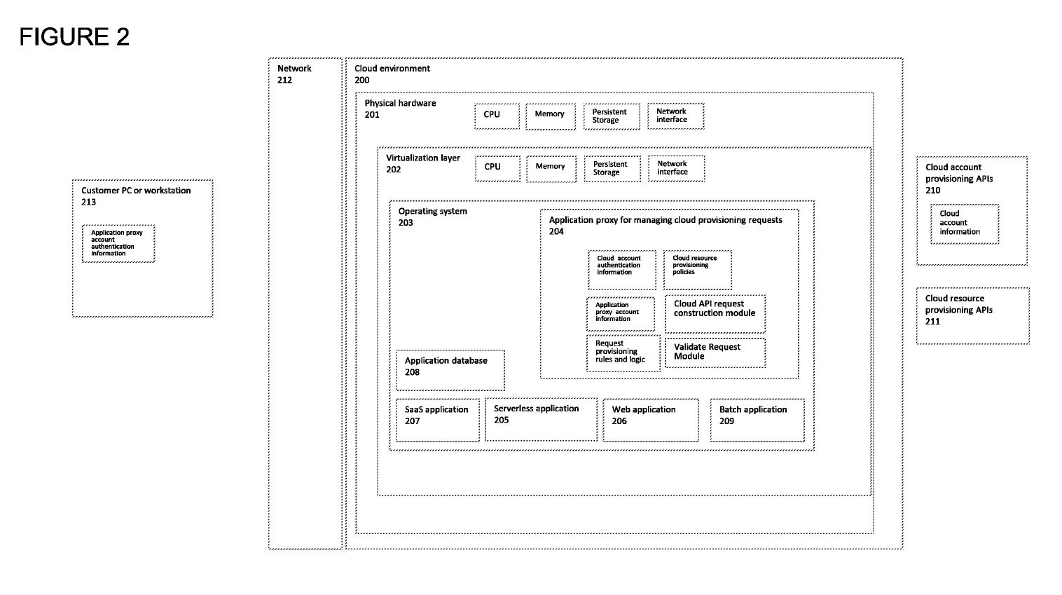

FIG. 2 is a system diagram, in accordance with an embodiment of the invention.

A cloud environment 200 is created by a cloud provider for a cloud customer. The environment consists of physical hardware 201, which may be virtualized 202 by a hypervisor or similar virtualization technology. An operating system 203 may be installed upon virtual or physical hardware, within which variation applications are installed.

An application proxy for managing cloud provisioning requests 204 is installed.

The application proxy for managing cloud provisioning requests 204 contains application proxy account information, which is used to authenticate requests for cloud provisioning from a customer PC or workstation 213.

The application proxy for managing cloud provisioning requests 204 contains cloud account information, which is used to provide authentication details in requests for cloud provisioning to the cloud resource provisioning APIs 211.

The application proxy for managing cloud provisioning requests 204 contains cloud resource provisioning policies, which is used to validate requests for cloud provisioning from a customer PC or workstation 213.

The application proxy for managing cloud provisioning requests 204 contains a validate request module, which uses the cloud resource provisioning polices to validate cloud provisioning requests from the customer PC or workstation 213.

The application proxy for managing cloud provisioning requests 204 contains a request provisioning rules and logic, which detail rules and logic for creating cloud provisioning requests to the cloud resource provisioning APIs 211, from cloud resource provisioning requests submitted by the customer PC or workstation 213.

The application proxy for managing cloud provisioning requests 204 contains a cloud API request construction modules, which uses the rules and logic for creating cloud provisioning requests and a cloud resource provisioning request submitted by the customer PC or workstation 213, to create and submit a request to the cloud resource provisioning APIs 211.

Various applications may be provisioned in the cloud environment, including serverless applications 205, web applications 206, SaaS software-as-a-service applications 207, application databases 208 and batch applications 209.

The cloud provider provides cloud resource provisioning APIs 211, which are called to provision applications into the cloud environment. These APIs rely on the cloud account provisioning APIs 210 to authenticate provisioning requests against cloud account information.

A customer's PC or workstation 213 constructs a request for a cloud subscription. Information entered by a user is combined with application proxy account information from persistent storage, which provides authentication details in the request from the customer's PC or workstation 213 to the application proxy for managing cloud provisioning requests 204.

Communication between the customer PC or workstation 213 and the cloud environment 200 is over a network 212 such as the internet, using the appropriate protocols such as HTTP/s, TCP/IP, with features such as encryption, routing, redundancy, and authentication provided by these protocols or additional protocols. The network 212 may be a local area network, wide area network, internet, private network, public network, wireless network, wired network, or the like.

The Customer PC or workstation 213 may include a server, desktop, laptop, mobile device, wearable device, smartphone, tablet, node, or the like.

The cloud environment 200 can be a single server or computing device or a plurality of computing devices, which may or may not be distributed across disparate physical locations and/or physical units. The computing devices and their hardware may be fixed or dynamically provisioned.

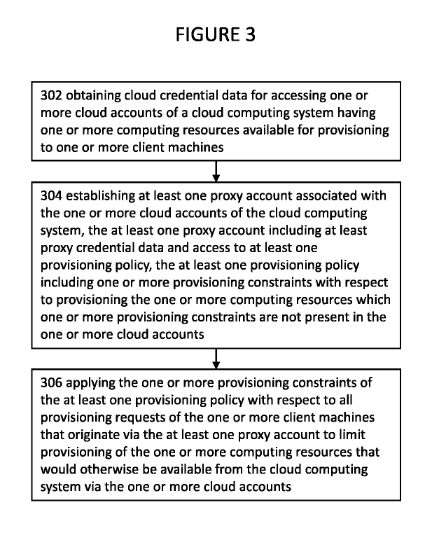

FIG. 3 is a flow diagram of a computer process, in accordance with an embodiment of the invention. Operations of FIG. 3 can be performed within the hardware environment discussed with respect to FIGS. 1-2.

In one embodiment, a computer process includes a cloud customer providing cloud credential data for accessing one or more cloud accounts of a cloud computing system having one or more computing resources available for provisioning to one or more client machines. For example, the customer PC or workstation 213 can provide the cloud environment 200 with cloud credential data for accessing one or more cloud accounts of the cloud environment 200. The cloud credential data can include a password, username, biometric information, or other security information for accessing a cloud account. This cloud credential data can be previously known or provided by the cloud environment or newly created and not yet associated with the cloud environment. The cloud account of the cloud computing system can include a root account or an admin account for a cloud computing system, which allows for unrestrained provisioning access to resources on the cloud computing system. Alternatively, the cloud account of the cloud computing system can be limited or secure in one or more respects, such as providing access to some, but not all, resource provisioning capabilities. In certain embodiments, the computing resources can include databases, applications, serverless applications, virtual machines, containers, web applications, batch applications, or other operational software. In other embodiments, the provisioning includes providing at least one of the following types of access to one or more resources: edit, delete, add, modify, configure, monitor, start, stop, enable, disable, etc. In further embodiments, the client machine can include any of a server, computer, desktop, laptop, tablet, smartphone, augmented reality goggles, virtual reality goggles, wearable, vehicle, or other computing device. Thus, cloud credential data of a cloud customer, who may be an employee or contractor of an organization with a cloud subscription, can be transmitted to the system and authenticate the employee or contractor for usage as is further described an illustrated herein.

In another embodiment, a computer process includes establishing at least one proxy account associated with the one or more cloud accounts of the cloud computing system, the at least one proxy account including at least proxy credential data and access to at least one provisioning policy, the at least one provisioning policy including one or more provisioning constraints with respect to provisioning the one or more computing resources which one or more provisioning constraints are not present in the one or more cloud accounts at 304.

For example, the customer PC or workstation 213 can create a request from user input and persistent storage, sending the request to the cloud environment 200 over a network 212. This request may contain cloud account credential data for accessing one or more cloud accounts of the cloud environment 200. The application proxy 204 receives the request and creates in persistent storage data for a new proxy account, and associates the proxy account with the cloud account in the request, the cloud account being identified using the cloud account credential data. A response is constructed and returned via the network 212 to the customer PC or workstation 214, which may contain the proxy account information including credential data to enable subsequent authentication and access to the proxy account.

For example, Alice has a username and password for a cloud account on a cloud environment. She enters these onto her PC, where software constructs a request to an API published by an application proxy installed on the cloud environment. The application proxy creates a new proxy account for Alice, with a new username and password, and saves the credential data for this new account, and the credential data for cloud account which was passed in the request, to persistent storage, associating the two accounts. The new username and password for the proxy account are returned to Alice in the response, and displayed to her on her PC.

In another embodiment, the customer PC or workstation 213 can create a request from user input and persistent storage, sending the request to the cloud environment 200 over a network 212. This request may contain cloud credential data for accessing one or more cloud accounts of the cloud environment 200 and credential data of an existing proxy account known to the application proxy 204. The application proxy 204 receives this request and creates in persistent storage the association between the existing proxy account identified using the proxy account credential data and the cloud account identified using the cloud account credential data. A response is constructed and returned via the network 212 to the customer PC or workstation 214.

For example, Alice has a username and password for a cloud account on a cloud environment, and a username and password for a proxy account known to an application proxy installed on the cloud environment. She enters these onto her PC, where software constructs a request to an API published by the application proxy installed on the cloud environment. The application proxy checks the credential data for the proxy account, and if authenticated, it saves the credential data for cloud account which was passed in the request, to persistent storage, and associates it with the proxy account. The results of this operation are returned to Alice in the response, and displayed to her on her PC.

The proxy account of the cloud computing system can include an existing account for a computing system, a new account created by the customer PC or workstation 213, a new account created by the application proxy 204, a new account created by the cloud account provisioning APIs 210, or a new account created by an external computing system such as an identity management system or other system.

The credential data can include a password, username, biometric information, or other security information for accessing an account. This credential data can be previously known or provided by the cloud environment or newly created and not yet associated with the cloud environment.

Provisioning policy may include declarative statements, scripts, compiled code, executable code, templates, scripts, or references to external artifacts or services.

The cloud environment may have various applications and artifacts provisioned, which may include one more application databases, SaaS applications, serverless applications, web applications, batch applications and similar artifacts which are created in a cloud environment. Provisioning of these applications or artifacts includes providing at least one of the following types of access to one or more resources: edit, delete, add, modify, configure, monitor, start, stop, enable, disable, etc. Provisioning constraints may permit or deny a provisioning request based on matching the characteristics of the request against the conditions in the provisioning policy, and may include external information, prior conditions being met, or dependent on subsequent additional conditions in the policy being met. Conditions in the policy may include a work flow requirement, multiple account approval requirement, provenance requirement, static analysis requirement, network capability requirement, resource relationship, use requirement, synchronous or asynchronous request fulfilment requirement.

Thus, a proxy account can be, in certain embodiments, associated with a cloud account with the ability to provision computing resources into a cloud environment, and also associated with provisioning policies which limit the provisioning of computing resources. Provisioning requests which are submitted using the proxy account can provision computing resources via the associated cloud account, but are limited by the associated provisioning policies.

In a further embodiment, a computer process includes applying the one or more provisioning constraints of the at least one provisioning policy with respect to all provisioning requests of the one or more client machines that originate via the at least one proxy account to limit provisioning of the one or more computing resources that would otherwise be available from the cloud computing system via the one or more cloud accounts at 306.

For example, the customer PC or workstation 213 can provide the cloud environment 200 with a request which contains a provisioning request and credential data for a proxy account. The application proxy 204 matches the credential data against the application proxy account information, and if matches, retrieves any associated cloud resource provisioning policies. The validation request module checks the provisioning request against the requirements of the cloud resource provisioning policies.

A provisioning policy may include declarative statements, scripts, compiled code, executable code, templates, or references to external artifacts or services. When a provisioning request is received, one or more validate request modules within the application proxy 204 will execute, and will compare the request against the requirements of the provisioning policy, using rules such as executing code or scripts contained within the provisioning constraints against all or part of the provisioning request and evaluating the result of the execution, submitting all or part of the provisioning request to an external artifact or service and evaluating the result returned by the external artifact or service, validating the existence or absence of previous provisioning requests to the application proxy (which may include previous submission of the current provisioning request under a different proxy account), comparing various attributes of the provisioning request against restrictions or requirements for those attributes as defined in the resource provisioning policy (such attributes may include the type of resource requested, the source of the resource, the geographical location of the request, the date or time of the request), and/or comparing various attributes of the target environment against restrictions or requirements for those attributes (such attributes may include network connections, hardware, the geographical location of target cloud servers, the security classification of the target cloud servers, the existence of database or application with particular characteristics, firewall rules, the cost of running or deploying an application or service). If the one or more validate request modules determine that the provisioning request fulfils the requirements of the provisioning policy, it is considered valid and may be submitted to the cloud provider API to enable the provisioning of the resource. Otherwise, the provisioning request is not valid and will not be submitted.

For example, if a provisioning request passes the validation performed by the one or more request validation modules within the application proxy 204, then one or more cloud API request construction modules within the application proxy 204 can use request provisioning rules and logic within the application proxy 204, to construct one or more provisioning requests for the cloud provider API, and submit this request or requests to the cloud provider API using the cloud account associated with the proxy account. If the request to the cloud provider API is valid, the cloud provider API will provision the requested resource into the cloud environment.

The client machine can include any of a server, computer, desktop, laptop, tablet, smartphone, augmented reality goggles, virtual reality goggles, wearable, vehicle, or other computing device. A number of client machines may participate in collecting information and constructing a provisioning request. Provisioning requests may be submitted from multiple client machines, with the same or different proxy account credentials in the provisioning request.

The permissions granted to a cloud account will generally allow a broad range of resources and artifacts to be provisioned within a cloud environment, and may provide access to operating system accounts. In contrast, provisioning policies can specify an arbitrary level of detail on the provisioning constraints to be applied by the one or more validate request modules with the application proxy 204. Resource provisioning requests which are submitted using the proxy account are limited by the these provisioning constraints, which may be additional to any constraints that may exist on the cloud account.

For example, a cloud account may have permission to provision web applications within the cloud environment. A provisioning policy may only allow requests which provision a web application which is built from source that is obtained from a particular source repository URL. Another provisioning policy may only perform the provisioning of a web application if the same provisioning request had previously been received from a different proxy account, thereby requiring the provisioning request to be submitted from two different proxy accounts before the request is submitted to the cloud provider API.

Thus, in certain embodiments, users are able to submit provisioning requests using the proxy account credentials, and these requests are validated against the one or more associated cloud resource provisioning policies. If valid, a request may be constructed and submitted to the cloud provisioning API, and a cloud resource can be provisioned into the cloud environment. For example, a user may have proxy account credentials in the form of a user name and password. These credentials have been previously associated with a cloud account and provisioning policies. A user may construct a provisioning request including these proxy account credentials, using for example a text editor or graphical user interface. The application proxy validates the proxy account credentials in the provisioning request against the stored proxy user account credentials, validates the provisioning request according to the associated provisioning polices, and if valid creates and submits a request to the cloud provisioning API.

For example, Alice has a username and password for a proxy account known to an application proxy installed on the cloud environment. She enters these credentials, and information on a web application she wishes to be provisioning into the cloud environment, onto her PC, where software constructs a request to an API published by the application proxy installed on the cloud environment. The application proxy checks the credential data for the proxy account, and if these are authenticated, the application proxy will continue to process the request. Alice's proxy account is associated with one provisioning policy, which permits her to provision web applications. The request is checked against this provisioning policy, using the one or more validation modules with the application proxy. In this example, the request complies with the restrictions of the provisioning policy. The application proxy then uses the request provisioning rules and logic to construct the appropriate request for the cloud provider API. Associated with Alice's proxy account are the credentials of a cloud account. Using the credentials of this cloud and the constructed API request, the application proxy calls the cloud provider API. The cloud provider API provisions the web application into the cloud environment, and application proxy returns the result of this operation is returned to Alice's PC, and it is displayed to her.

As another example, a user may have previously logged onto a local area network and workstation or PC by authenticating to an Active Directory server with a username and password. The Active Directory credentials have been previously associated with a cloud account and provisioning policies. A user may construct a provisioning request using for example a text editor or graphical user interface. The application proxy uses an authentication package such as NTLM or Kerberos to validate the account credentials, validates the request according to the associated provisioning polices, and if valid creates and submits a request to the cloud provisioning API.

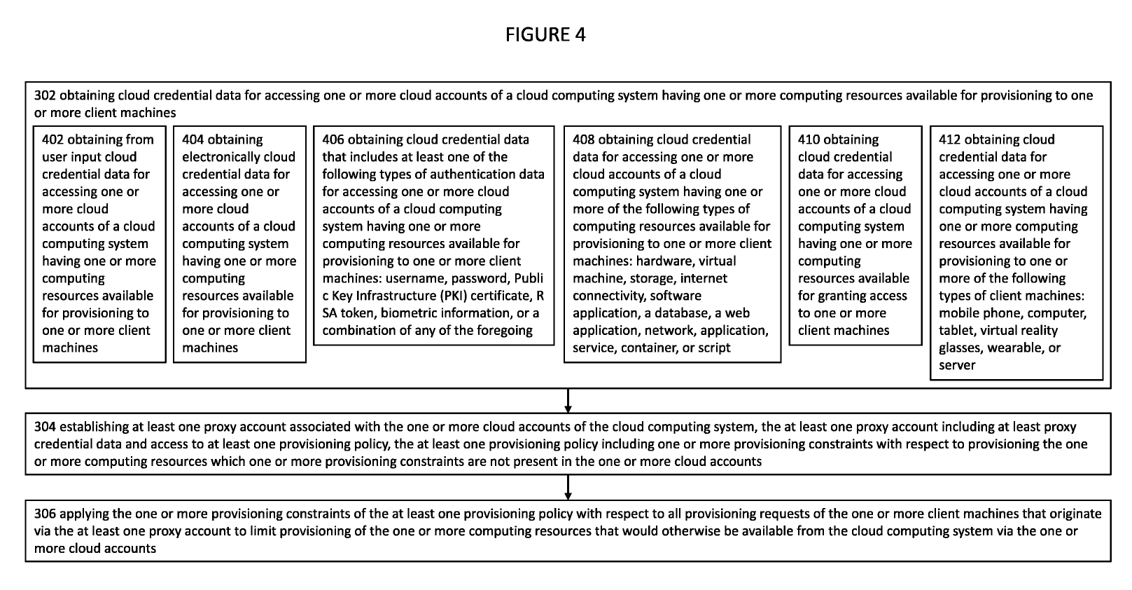

FIG. 4 is a flow diagram of a computer process, in accordance with an embodiment of the invention.

In one embodiment, a computer process includes obtaining from user input cloud credential data for accessing one or more cloud accounts of a cloud computing system having one or more computing resources available for provisioning to one or more client machines at 402.

For example, the computer PC or workstation 101 or 1101 or 1201 or 213 may accept the user input including cloud credential data for accessing one or more cloud accounts of the cloud computing system 103 or 1103 or 1203 or 200 (e.g., from cloud account store 1110 or cloud account provisioning APIs 210).

In certain embodiments, the user input may include one or more of user actions, data from hardware devices, and data retrieved from persistent storage. For instance, user input may be captured using peripheral hardware such as a touch screen, gamepad, keyboard, mouse, joystick, microphone, motion detector, or mobile phone. The user input may be provided via a user interface such as a graphical user interface, which may be presented to a user on peripheral hardware such as screen, virtual reality device, augmented reality device, or projected. Additionally, the user input may be provided via typing into a keyboard, which may be physical, projected, or on a touch screen. Firmware or software may be implemented in a peripheral hardware unit to allow it function and transfer of data to and from the peripheral hardware such as the user workstation or PC. Specific examples of user input or user input mechanisms may include gestures (finger pointing, eye movement, hand motion, hand/finger arrangement, body position, head orientation, body or limb orientation); speech (e.g., word, phrase, sentence, sound, recorded audio data); touch screen (e.g., capacitive, resistive, infra-red touch, projected capacitive, touch or proximity activated); data retrieval (e.g., received from a persistent storage device, which may local or remote to a user); device information retrieval (e.g., without direct user action, location from geolocation device, a network IP address from a network adapter, acceleration from an accelerometer, spatial information from a tilt-sensor, from client workstation or PC or smartphone or mobile device or networked device, USB, or smartcard); biometric data (e.g., iris or fingerprint information obtained from a biometric device); obtained token (e.g., a token obtained from a device such as a RSA SECURED device, on-demand token, token from text message or phone call or email or other communication); the scan of a physical token including an identification such as a security badge, driver's license, passport or bank card; cryptographic key (e.g., retrieved from persistent storage); challenge response authentication protocol (e.g., NTLM, Kerberos, SPNEGO, or other negotiation mechanism); multi-factor authentication request response; or multi-modal input (e.g., multiple modes of input action).

For example, a user may speak to a smartphone device and make a request to provision data in a cloud environment. The smartphone device may use its camera, screen, or touch button to capture biometric data regarding the user making the provisioning request. Moreover, the smartphone device can capture data from a smartcard, such as an RFID card carried or proximate to a user. This combined data can be packaged as the user input for the provisioning request and transmitted via cellular or wireless network communication for interception by a proxy system for evaluation.

In another example, a user uses a camera on a mobile device to scan a security badge. Software installed on the phone decodes the information on the badge. The user provides a fingerprint scan to their mobile device and this information is cross-referenced to confirm identity with the security badge information. This information and the confirmed identity is sent to the proxy system and decoded. A discrepancy may produce a challenge to the user in the form of a one-time token to their email address to allow a retry of the authentication.

In one embodiment, a computer process includes 404 obtaining electronically cloud credential data for accessing one or more cloud accounts of a cloud computing system having one or more computing resources available for provisioning to one or more client machines at 404.

For example, the computer PC or workstation 101 or 1101 or 1201 or 213 may obtain electronically cloud credential data for accessing one or more cloud accounts of the cloud computing system 103 or 1103 or 1203 or 200 (e.g., from cloud account store 1110 or cloud account provisioning APIs 210).

In certain embodiments, the cloud environment 103 or the application proxy 304 or the cloud environment 1203 or the application proxy 204 will obtain cloud credential data in order to access one or more cloud accounts of a cloud computing system having one or more computing resources available for provisioning to one or more client machines. For instance, a computer process can obtain the cloud credential data by electronic means, such as retrieval from persistent or temporary storage, which may be on the hardware of the computer, such as CPU cache, RAM, or connected hardware such as solid state or disk or tape, or associated hardware such as a removable media or a smart card. Alternatively, a computer process could obtain the cloud credential data using a request to a local or remote service, the local service being accessed over a local bus or hardware connection, the remote service being accessed over a network via a network adapter. The retrieved credential data may be encrypted; if a computer process performs decryption it may perform this decryption locally or remotely. Furthermore, retrieved credential data may be generated in real-time, using a computer process for generating credential data, which may involve cryptographic processes such as asymmetric encryption. Alternatively, a computer process may obtain a reference to the cloud credential data, such as a uniform resource identifier, and use this reference as a means of retrieving the cloud credential data. Further, retrieved credential data may be sent from an external source, such as an identity management system or cloud computing system, as a permanent or temporary credential data, such as a request-based or session-based token, which is used to access the one or more cloud accounts of a cloud computing system. Alternatively, cloud credential data may be one or more physical attributes of hardware, or connected or associated hardware, and may obtained using the features of the underlying operating system or device drivers. Moreover, obtaining cloud credential data may consist of a combination of the above, where a computer process constructs the credential data from data obtained from more than one source.

For example, a computer process may access credential data stored on a USB flash drive attached to the computer PC or workstation. Moreover, this credential data may be encrypted, and decryption may be performed by the computer process using data such as a decryption key, which may be obtained from non-persistent memory having been obtained earlier from user input. Additional credential data may be obtained from electronically accessing an identity management system over a network, using session-based tokens stored on the computer PC or workstation from previous authentication to the identity management system, and accessible to the computer process.

In one embodiment, a computer process includes obtaining cloud credential data that includes at least one of the following types of authentication data for accessing one or more cloud accounts of a cloud computing system having one or more computing resources available for provisioning to one or more client machines: username, password, Public Key Infrastructure (PKI) certificate, RSA token, biometric information, time-based token, or a combination of any of the foregoing at 406.

For example, the computer PC or workstation 101 or 1101 or 1201 or 213 may obtain cloud credential data for accessing one or more cloud accounts of the cloud computing system 103 or 1103 or 1203 or 200 (e.g., from cloud account store 1110 or cloud account provisioning APIs 210). This cloud credential data obtained allows subsequent authorization to the cloud account provisioning APIs 210 and cloud resource provisioning APIs 211, and as such includes at least the type or types of authentication data accepted by these APIs.

In certain embodiments, the cloud credential data may include a username, which may be selected by a user, assigned randomly by a computer process, or assigned by a computer process based on criteria pertaining to the user, account, or other data that is deemed relevant. Additionally, the cloud credential data may include a password, which may be selected by a user, assigned randomly by a computer process, or assigned by a computer process based on criteria pertaining to the user, account, or other data that is deemed relevant. Knowledge of a username-password combination is taken by the APIs as establishing authentication as a user for accessing the one or more cloud accounts of a cloud computing system.

Alternatively, the cloud credential data may include a Public Key Infrastructure (PKI) certificate, where a public-private key-pair is generated by a computer process, and knowledge of the private key is required to asymmetrically sign data. The data signature can be validated by the public key; this authenticates knowledge of the private key, and this knowledge is taken by the APIs as establishing authentication as a user for accessing the one or more cloud accounts of a cloud computing system.

Alternatively, a time-based token may be provided as authentication data. This token may be generated by the cloud computing system or a trusted third party. The token may expire at a certain time, after a certain duration of idleness, or after a certain number of uses.

Alternatively, an RSA device or similar may be provided which generates tokens, which are required as authentication data. This is generally, but not necessarily, used in combination with another kind of authentication as part of a multi-factor authentication technique.

Alternatively, biometric data may be provided as authentication data. This is generally, but not necessarily, used in combination with another kind of authentication as part of a multi-factor authentication technique.

Alternatively, the cloud credential data may include a time-stamped token such as a ticket-granting ticket, which is obtained after authentication to a ticket-granting service by some means such as described above. The ticket-granting ticket can be used to generate ticket and session keys, and this ticket and/or keys are taken by the APIs as establishing authentication as a user for accessing the one or more cloud accounts of a cloud computing system. As an example of such an embodiment, the Kerberos protocol may be supported by the cloud computing system.

For example, the computer process may obtain a username and password, which are sent to the cloud computing system as authentication data. If authenticated, the cloud computing system returns a time-based token, which is valid for several minutes. This time-based token may be sent with subsequent requests, which authenticates these subsequent requests to the cloud computing system APIs.

In one embodiment, a computer process includes obtaining cloud credential data for accessing one or more cloud accounts of a cloud computing system having one or more of the following types of computing resources available to one of more client machines for provisioning: hardware, virtual machine, storage, internet connectivity, software application, a database, a web application, network, application, service, container, or script at 408.

For example, the computer PC or workstation 101 or 1101 or 1201 or 213 may obtain cloud credential data for accessing one or more cloud accounts of the cloud computing system 103 or 1103 or 1203 or 200 (e.g., from cloud account store 1110 or cloud account provisioning APIs 210). The cloud computing system, using the capabilities in the cloud resource provisioning APIs 211, can provision physical hardware 201, virtual machines 202, operating systems 203, applications such as batch applications 209, application databases 208, SaaS applications 207, serverless applications 205, web applications 206, and other such physical infrastructure or software applications as may be available for provisioning.

The cloud computing system may provision these physical infrastructure or software applications in the same cloud environment as the one which the cloud resource provisioning APIs reside, different cloud environments, client machines which are not cloud environments, or a hybrid combination of various deployment models. For example, when provisioning resources in a cloud provider, they may be provisioned onto hardware owned and maintained by the cloud provider. Alternatively, resources may be provisioned remotely onto dedicated data centers on infrastructure owned by the requestor or a third-party. Resources may be virtualized using a virtualization technology such as a hypervisor, or be provisioned using dedicated hardware. The provisioned resource may be selected from a catalog, marketplace, customized from a template, or specified in a bespoke manner in the provisioning request. The provisioned resource may follow an Infrastructure as a Service (IaaS) model, Platform as a Service (PaaS) model, Container as a Service (CaaS) model, Software as a Service (SaaS) model, a Function as a Server (FaaS, or serverless application) model, or a combination of these.

In one embodiment, the cloud computing system provisions persistent storage, which may have persistence and retrieval performance and pricing characteristics depending on the request or other factors.

In another embodiment, the cloud computing system provisions internet connectivity, providing the required infrastructure such as network interfaces and appropriate firewalling.

In another embodiment, the cloud computing system provisions a software application, which may be provided in the request as a compiled unit, or provided in the request as source code or script requiring compilation or runtime interpretation, or provided in the request using a reference such as URI which may reference a compiled unit, source code or scripting, or provided in the request using a reference such as reference to a catalogue, store, repository, or existing pool of deployed or ready-to-be-deployed applications. The software application provisioning may include access permissions, related to existing or newly created users specific to the database or known to external systems. The software application may include network connectivity which may be limited to particular clients and may include security requirement such as authentication.

In another embodiment, the cloud computing system provisions a database, which may have persistence and retrieval performance and pricing characteristics depending on the request or other factors. The database provisioning may include access permissions, related to existing or newly created users specific to the database or known to external systems. The database provisioning may include network connectivity which may be limited to particular clients and may include security requirement such as authentication.

In another embodiment, the cloud computing system provisions a web application, which may be provided in the request as a compiled unit, or provided in the request as source code or script requiring compilation or runtime interpretation, or provided in the request using a reference such as URI which may reference a compiled unit, source code or scripting, or provided in the request using a reference such as reference to a catalogue, store, repository, or existing pool of deployed or ready-to-be-deployed applications. The web application provisioning may include access permissions, related to existing or newly created users specific to the database or known to external systems. The web application provisioning may include network connectivity which may be limited to particular clients and may include security requirement such as authentication.

In another embodiment, the cloud computing system provisions a service, which may be provided in the request as a compiled unit, or provided in the request as source code or script requiring compilation or runtime interpretation, or provided in the request using a reference such as URI which may reference a compiled unit, source code or scripting, or provided in the request using a reference such as reference to a catalogue, store, repository, or existing pool of deployed or ready-to-be-deployed applications. The service provisioning may include access permissions, related to existing or newly created users specific to the database or known to external systems. The service provisioning may include network connectivity which may be limited to particular clients and may include security requirement such as authentication.

In another embodiment, the cloud computing system provisions a network, such as a virtual private network or a software defined network, with network naming and interfaces defined to allow entities such as software applications to participate in the network. The network may include network connectivity which may be limited to particular clients and may include security requirement such as authentication.

In another embodiment, the cloud computing system provisions a container, which may be provided in the request as an image, or provided in the request as an image description or script, or provided in the request using a reference such as URI which may reference an image, image description or script, or provided in the request using a reference such as reference to a catalogue, store, repository, or existing pool of deployed or ready-to-be-deployed applications. The software application provisioning may include access permissions, related to existing or newly created users specific to the database or known to external systems. The database provisioning may include network connectivity which may be limited to particular clients and may include security requirement such as authentication.

For example, the cloud account can be used to request the provisioning of a web application onto the cloud infrastructure. This request would include details of the web application and the platform required to run the web application. The cloud computing system uses the cloud account to authenticate and authorize the request to the cloud resource provisioning API, which may use templates to provision the infrastructure, virtualization layer, and platform required for the web application, and then installs the web application onto the provisioned platform. In another example, the cloud account can be used request the provisioning of a serverless application. This request can include, either directly or by reference to a URI or similar, the code of the serverless application, and its runtime parameters such as maximum CPU, maximum memory usage, and network connections. The cloud computing system deploys the serverless application onto a virtualized environment and manages per the runtime parameters.

In one embodiment, a computer process includes 410 obtaining cloud credential data for accessing one or more cloud accounts of a cloud computing system having one or more computing resources available for granting access to one or more client machines at 410.

A client machine, such as a customer PC or workstation 410, or a computer process such as an application proxy 204, can create requests to be submitted to the cloud environment 200 to obtain cloud credential data for the cloud environment computing system, the cloud computing system having one or more computing resources available for granting access to one or more client machines at 410.

For example, a computer process obtains cloud credential data for a new cloud account using a cloud account provisioning API, which will enable authentication to a cloud resource provisioning API. The cloud account provisioning API can provision a computing resource which will allow a client machine to gain access to the cloud computing system, including other resources that may be provisioning on the cloud computing system.

In one embodiment, a computer process includes obtaining cloud credential data for accessing one or more cloud accounts of a cloud computing system having one or more computing resources available for provisioning to one or more of the following types of client machines: mobile phone, computer, tablet, virtual reality glasses, wearable, or server at 412.

A client machine, such as a customer PC or workstation 213, can create requests to be submitted to the cloud environment 200 to obtain cloud credential data for accessing one or more cloud accounts of the cloud environment 200.

The client machine may include a server, desktop, laptop, mobile device, wearable device, smartphone, tablet, node, or the like, such that the machine has the capacity to request and obtain the credential data to access the one or more accounts of the cloud environment.

The client machine may constitute more than one device working in combination to provide the required capacity to request and obtain the credential data to access the one or more accounts of the cloud environment.

The client machine may include specialized hardware, such as a smart watch or virtual reality glasses, which may not in themselves have the required capacity to request and obtain the credential data to access the one or more accounts of the cloud environment, but can be used in combination with other devices.

A client machine, such as a customer PC or workstation 213, can create requests to be submitted to the cloud environment 200 with cloud credential data for accessing one or more cloud accounts of the cloud environment 200.

The client machine may include a server, desktop, laptop, mobile device, wearable device, smartphone, tablet, node, or the like, such that the machine has the capacity to use the credential data to access the one or more accounts of the cloud environment.

The client machine may constitute more than one device working in combination to provide the required capacity to use the credential data to access the one or more accounts of the cloud environment.

The client machine may include specialized hardware, such as a smart watch or virtual reality glasses, which may not in themselves have the required capacity to use the credential data to access the one or more accounts of the cloud environment, but can be used in combination with other devices.

A client machine, such as a customer PC or workstation 213, can create requests to be submitted to the cloud environment 200 with cloud credential data for accessing one or more cloud accounts of the cloud environment 200, having computing resources provisioned to client machines.

The client machine may include a server, desktop, laptop, mobile device, wearable device, smartphone, tablet, node, or the like, such that the machine has the capacity to be provisioned with computing resources.

The client machine may constitute more than one device working in combination to provide the required capacity to be provisioned with computing resources.

The client machine may include specialized hardware, such as a smart watch or virtual reality glasses, which may not in themselves have the required capacity to be provisioned with the computing resource, but can be used in combination with other devices.

A client machine, such as a customer PC or workstation 213, can create requests to be submitted to the cloud environment 200 with cloud credential data for accessing one or more cloud accounts of the cloud environment 200, having computing resources provisioned to client machines, after which the computing resources are accessible to the client machine.

The client machine may include a server, desktop, laptop, mobile device, wearable device, smartphone, tablet, node, or the like, such that the machine has the capacity to access the computing resources.

The client machine may constitute more than one device working in combination to provide the required capacity to access the computing resources.

The client machine may include specialized hardware, such as a smart watch or virtual reality glasses, which may not in themselves have the required capacity to be access the computing resource, but can be used in combination with other devices.

A mobile phone may use its computing, networking and storage capabilities to construct, send, and receive requests of a cloud computing system. Cloud credential data which is obtained from the cloud computing system may be saved to persistent storage. The cloud computing system may provision computing resources to a customer PC or workstation, and the provisioned resource is then accessible to the mobile phone.

Similarly, a networked PC, workstation or tablet may use its computing, networking and storage capabilities to construct, send, and receive requests of a cloud computing system. Cloud credential data which is obtained from the cloud computing system may be saved to persistent storage. The cloud computing system may provision computing resources, and the provisioned resource is then accessible to the networked PC, workstation or tablet.

In another embodiment, a wearable computer device such as a smart watch or VR google may construct a request from user input, and leverage a supporting device such as a mobile phone, networked PC, workstation or tablet to construct, send, and receive requests of a cloud computing system. Cloud credential data which is obtained from the cloud computing system may be saved to persistent storage. The cloud computing system may provision computing resources, and the provisioned resource is then accessible to the wearable device.

For example, a user activates an icon on their watch, and speaks a passphrase and request into the watch's microphone. The phrase and voice pattern are recorded and sent to the user's mobile phone using Bluetooth. The mobile phone verifies the phrase and voice patterns, and sends a request to a cloud computing system to obtain cloud credential data. The mobile phone uses this credential data to request for computing resources to be provisioned to a remote server. The computing resources on the remote server are then accessible to the user's watch.

For example, Alice wishes to create a cloud computing environment, with provisioning restrictions she has detailed in a number of provisioning policies. First, she obtains the username and password for a cloud account, by subscribing to a cloud environment using the subscription web page for a cloud provider, entering personal details and credit card details. She uses this cloud account to provision an application proxy onto the cloud environment, and provides the application proxy with credential data to authenticate herself to the application proxy, which in this example includes a username, biometric data in the form of her fingerprint, and her mobile number to allow for authentication challenges using a security token. The application proxy saves this credential data as a proxy account. The application proxy obtains the username and password for a cloud account by calling the cloud provider's API, and stores these credentials associated with Alice's proxy account. The application proxy disables Alice's cloud account, which she obtained as part of her subscription, for example by resetting the password to a random value and disallowing the password to be reset. Alice can upload her provisioning policies to the application proxy, authenticating herself to the application proxy with her proxy account credentials. The application proxy associates these provisioning policies to her proxy account. Alice requests a proxy account for Bob, from the application proxy, authenticating herself to the application proxy with her proxy account credentials, and passing a username and email address for Bob. In this example, the application proxy emails a password to Bob, creates a new proxy account for Bob with the credential information of his username, email address and password, associating this proxy account with the provisioning policies, and associating this proxy account with the active cloud account. Alice and Bob can now send provisioning requests to the proxy application, which will apply the provisioning policies and constrain their requests to those allowed by the provisioning policies. Request that are allowed by the provisioning policies will be submitted to the cloud environment using the active cloud account.

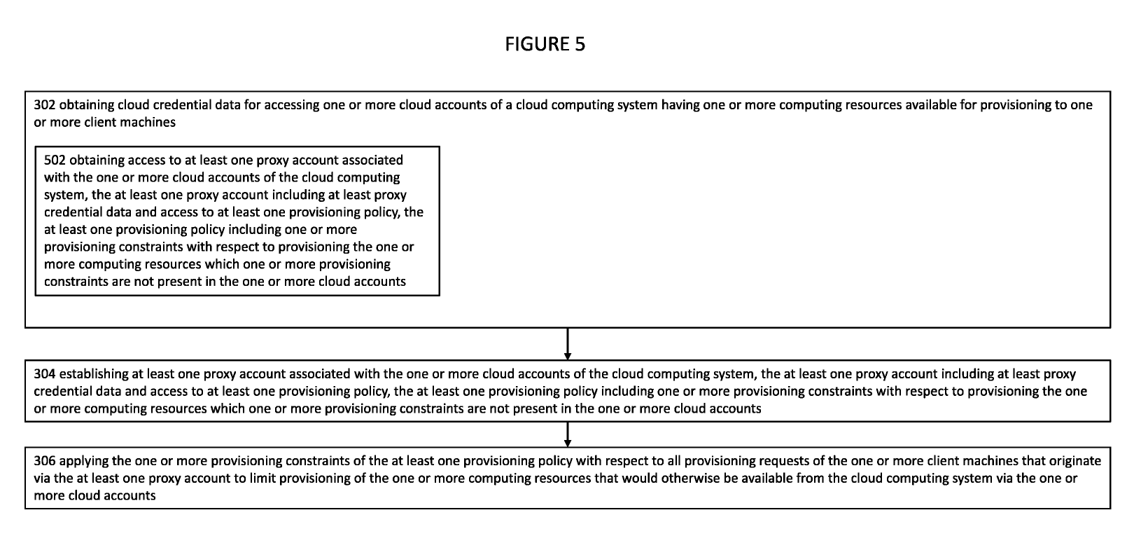

FIG. 5 is a flow diagram of a computer process, in accordance with an embodiment of the invention.

In one embodiment, a computer process includes obtaining access to at least one proxy account associated with the one or more cloud accounts of the cloud computing system, the at least one proxy account including at least proxy credential data and access to at least one provisioning policy, the at least one provisioning policy including one or more provisioning constraints with respect to provisioning the one or more computing resources which one or more provisioning constraints are not present in the one or more cloud accounts at 502.

A client machine, such as a customer PC or workstation 213, can create requests to be submitted to the cloud environment 200 with cloud credential data for accessing one or more cloud accounts of the cloud environment 200, having computing resources provisioned to client machines, after which the computing resources are accessible to the client machine. A request may consist of data from user input and persistent storage. One such request, submitted to the cloud environment from the client machine, is processed by the application proxy 1104, and the application returns credential data for accessing a proxy account associated with the one or more cloud accounts of the cloud computing system.

In one embodiment, a proxy account exists in a cloud computing environment. A user or process at a client machine creates a request with credential information which will be accepted by an application proxy, which has been provisioned onto the cloud environment and has access to one or more proxy accounts. The application proxy validates the request, and if the request is valid then credential data for the proxy account is returned to the user or process. This credential data can be sent to the application proxy to access the proxy account.

In another embodiment, a proxy account exists locally to the client machine. A user or process on a client machine authenticates to the client machine with credentials that will be accepted by the process on the client machine. For example, the user may log on to an operating system on the client machine, using a username and password, or may have their credentials validated by a process on the client machine using an authentication protocol such as Kerberos or SPNEGO, or may enter separate credentials to a process on the client machine. If the credentials are validated, then the computer process can access the proxy account.

In another embodiment, a proxy account exists on a remote machine which is networked to the client machine. A user or process on a client machine authenticates over the network to a process on the remote machine with credentials that will be accepted by the process on the remote machine. For example, the user or process may perform a remote logon to an operating system on the remote machine, using a username and password, or may have their credentials validated by a process on the remote machine using an authentication protocol such as Kerberos or SPNEGO, or may enter separate credentials to a process on the remote machine. If the credentials are validated, then the computer process can access the proxy account over the network.

In another embodiment, a proxy account exists in an identity management system. A user or process on a client machine authenticates to the identity management system. For example, the user or process may perform a logon to the identity management system on a local or remote machine, using a username and password, or may have their credentials validated by the identity management using an authentication protocol such as Kerberos or SPNEGO. If the credentials are validated, then the identity management system can return details of the proxy account.

In another embodiment, a proxy account exists on a device which is attached to the client machine. A user or process on a client machine authenticates to a process with access to the attached device. For example, the attached device may be mounted onto the client machine's operating system and the user may perform a logon to an operating system on the client machine, using a username and password. In another example, the client machine may communicate to the attached device over a network or other protocol. The credentials may be validated by a process on the attached device using an authentication protocol such as Kerberos or SPNEGO, or credentials may be passed using a network or other protocol to a process on the attached device. If the credentials are validated, then the computer process can access the proxy account.

For example, a process running on a PC needs access to a proxy account, to construct a request to provision a resource onto a cloud computing system. The process accesses a USB device attached to the PC which contains the proxy account. The USB device contains a security process which requires an access key, which the process running on the PC obtains from persistent storage. The process on the USB device returns the details of the proxy account, which the process on the PC uses in the request to the application proxy. The application proxy uses the details of the proxy account, to process the client's request.

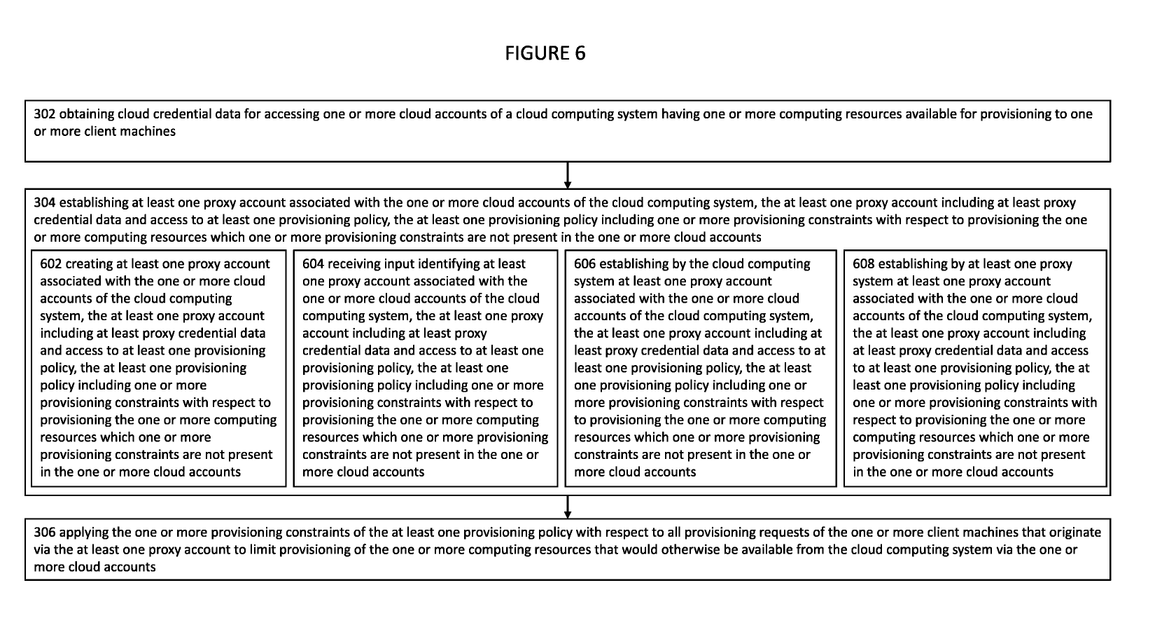

FIG. 6 is a flow diagram of computer process, in accordance with an embodiment of the invention.

In one embodiment, a computer process includes creating at least one proxy account associated with the one or more cloud accounts of the cloud computing system, the at least one proxy account including at least proxy credential data and access to at least one provisioning policy, the at least one provisioning policy including one or more provisioning constraints with respect to provisioning the one or more computing resources which one or more provisioning constraints are not present in the one or more cloud accounts.

A client machine, such as a customer PC or workstation 213 sends a request to the cloud environment 200 over a network 212. The application proxy 204 receives the request and creates in persistent storage data for a new proxy account in a user authentication store 1105, associates the proxy account with a cloud account in the cloud account store 1110, and associates the proxy account with one more provisioning constraints in the cloud resource provisioning policy store 1107.

In one embodiment, a proxy account is created in a cloud computing environment, associated with an existing cloud account, and associated with one or more existing provisioning constraints. A user or process at a client machine creates a request with credential information for a new proxy account, credential data for an existing cloud account, and a reference to one or more existing provisioning constraints. The credential information for the new proxy account, and the reference to one or more provisioning constraints, are accepted by a proxy application in the cloud environment, saved to persistent storage as a new proxy account, and associated with the credential information for the existing cloud account.

In another embodiment, a proxy account is created on a client machine, associated with an existing cloud account, and associated with one or more existing provisioning constraints. A user or process on the client machine creates a request with credential information for a new proxy account, credential data for an existing cloud account, and a reference to one or more existing provisioning constraints. This request is sent over a network, and a process on the client machine accepts the credential information for the new proxy account, and the reference to one or more provisioning constraints, are saved to persistent storage on the client machine as a new proxy account, and associated with the credential information for the existing cloud account.

In another embodiment, a proxy account is created on a remote machine, associated with an existing cloud account, and associated with one or more existing provisioning constraints. A user or process on the client machine creates a request with credential information for a new proxy account, credential data for an existing cloud account, and a reference to one or more existing provisioning constraints. This request is sent over a network, and a process on the remote machine accepts the credential information for the new proxy account, and the reference to one or more provisioning constraints, are saved to persistent storage on the remote machine as a new proxy account, and associated with the credential information for the existing cloud account.

In another embodiment, a proxy account is created on a device attached to a machine, associated with an existing cloud account, and associated with one or more existing provisioning constraints. A user or process on the client machine creates a request with credential information for a new proxy account, credential data for an existing cloud account, and a reference to one or more existing provisioning constraints. A process on the device attached a machine accepts the credential information for the new proxy account, and the reference to one or more provisioning constraints, are saved to persistent storage on the device attached to a machine as a new proxy account, and associated with the credential information for the existing cloud account.

In each embodiment, the proxy account created and associated with a cloud account or provisioning constraints may be additional to an existing proxy account created and associated with an account or provisioning constraints.

In each embodiment, the user or process creating a request or account, submitting a request, accepting information, saving to persistent storage, associating with an existing cloud account, or performing any processing or transmission, may consist of multiple users and/or processes.

Alternatively, in place of a reference to one or more existing provisioning constraints in the request, a user or process on a client machine can send one or more provisioning constraints, which are saved to persistent storage and associated with the new proxy account.

Alternatively, in place of credential data for a new proxy account, a user or process on a client machine can send the required data for the creation of a new proxy account. The application proxy, or process on a local or remote machine or device attached to a machine, submits the required data for a new proxy account to a suitable identity management system, to create a new proxy account, and the credential data returned by the API is saved to persistent storage.

Alternatively, in place of the existing cloud account in the request, a user or process on a client machine can send the required details for a new cloud account. The application proxy, or process on a local or remote machine or device attached to a machine, submits the required data for a new cloud account to the cloud identity management API or similarly authorized identity management system, to create a new cloud account, and the credential data returned by the API is associated with the proxy account.

Alternatively, in place of the one or more provisioning constraints in the request, and/or the existing cloud account in the request, the application proxy, or process on a local or remote machine or device attached to a machine, can default to existing or new provisioning constraints and/or an existing or new cloud account.

For example, a PC receives input from a user of a username, password, reference to an existing provisioning policy, and credentials of a cloud account. This information is send to a proxy application installed on a cloud server, which saves the username, password, and cloud account credentials to persistent storage, as a proxy account, and links the proxy account to the existing provisioning policy. A user of the PC can later enter the username and password of the proxy account; these can be submitted in a request to the proxy application installed on a cloud server. The proxy application which is installed on the cloud server can use the username and password to authenticate the request, and thereby access the stored proxy account and the associated provisioning policy and credentials of a cloud account.

In one embodiment, a computer process includes receiving input identifying at least one proxy account associated with the one or more cloud accounts of the cloud computing system, the at least one proxy account including at least proxy credential data and access to at least one provisioning policy, the at least one provisioning policy including one or more provisioning constraints with respect to provisioning the one or more computing resources which one or more provisioning constraints are not present in the one or more cloud accounts.

For example, the computer PC or workstation 101 or 1101 or 1201 or 213 may accept the user input including credential data for accessing one or more proxy accounts of the cloud computing system 103 or 1103 or 1203 or 200 (e.g., from a user authentication store containing proxy account credential data 1105, or proxy account provisioning APIs).

In certain embodiments, the input may include one or more of user actions, data from hardware devices, and data retrieved from persistent storage. For instance, user input may be captured using peripheral hardware such as a touch screen, gamepad, keyboard, mouse, joystick, microphone, motion detector, or mobile phone. The user input may be provided via a user interface such as a graphical user interface, which may be presented to a user on peripheral hardware such as screen, virtual reality device, augmented reality device, or projected. Additionally, the user input may be provided via typing into a keyboard, which may be physical, projected, or on a touch screen. Firmware or software may be implemented in a peripheral hardware unit to allow it function and transfer of data to and from the peripheral hardware such as the user workstation or PC. Specific examples of user input or user input mechanisms may include gestures (finger pointing, eye movement, hand motion, hand/finger arrangement, body position, head orientation, body or limb orientation); speech (e.g., word, phrase, sentence, sound, recorded audio data); touch screen (e.g., capacitive, resistive, infra-red touch, projected capacitive, touch or proximity activated); data retrieval (e.g., received from a persistent storage device, which may local or remote to a user); device information retrieval (e.g., without direct user action, location from geolocation device, a network IP address from a network adapter, acceleration from an accelerometer, spatial information from a tilt-sensor, from client workstation or PC or smartphone or mobile device or networked device, USB, or smartcard); biometric data (e.g., iris or fingerprint information obtained from a biometric device); obtained token (e.g., a token obtained from a device such as a RSA SECURED device, on-demand token, token from text message or phone call or email or other communication); the scan of a physical token including an identification such as a security badge, driver's license, passport or bank card; cryptographic key (e.g., retrieved from persistent storage); challenge response authentication protocol (e.g., NTLM, Kerberos, SPNEGO, or other negotiation mechanism); multi-factor authentication request response; or multi-modal input (e.g., multiple modes of input action).

For example, a user may speak to a smartphone device and make a request to provision data in a cloud environment. The smartphone device may use its camera, screen, or touch button to capture biometric data regarding the user making the provisioning request. Moreover, the smartphone device can capture data from a smartcard, such as an RFID card carried or proximate to a user. This combined data can be packaged as the user input for the provisioning request and transmitted via cellular or wireless network communication for interception by a proxy system for evaluation.

In another example, a user uses a camera on a mobile device to scan a security badge. Software installed on the phone decodes the information on the badge. The user provides a fingerprint scan to their mobile device and this information is cross-referenced to confirm identity with the security badge information. This information and the confirmed identity is sent to the proxy system and decoded. A discrepancy may produce a challenge to the user in the form of a one-time token to their email address to allow a retry of the authentication.

In one embodiment, a computer process includes 404 obtaining electronically credential data for accessing one or more proxy accounts associated with the one or more cloud accounts of the cloud computing system, the at least one proxy account including at least proxy credential data and access to at least one provisioning policy, the at least one provisioning policy including one or more provisioning constraints with respect to provisioning the one or more computing resources which one or more provisioning constraints are not present in the one or more cloud accounts.

For example, the computer PC or workstation 101 or 1101 or 1201 or 213 may obtain electronically the credential data for accessing one or more proxy accounts of the cloud computing system 103 or 1103 or 1203 or 200 (e.g., from proxy account store or proxy account provisioning APIs).

In certain embodiments, the cloud environment 103 or the application proxy 304 or the cloud environment 1203 or the application proxy 204 will obtain proxy account credential data in order to access one or more proxy accounts of a cloud computing system. For instance, a computer process can obtain the proxy account credential data by electronic means, such as retrieval from persistent or temporary storage, which may be on the hardware of the computer, such as CPU cache, RAM, or connected hardware such as solid state or disk or tape, or associated hardware such as a removable media or a smart card. Alternatively, a computer process could obtain the proxy account credential data using a request to a local or remote service, the local service being accessed over a local bus or hardware connection, the remote service being accessed over a network via a network adapter. The retrieved credential data may be encrypted; if a computer process performs decryption it may perform this decryption locally or remotely. Furthermore, retrieved credential data may be generated in real-time, using a computer process for generating credential data, which may involve cryptographic processes such as asymmetric encryption. Alternatively, a computer process may obtain a reference to the proxy account credential data, such as a uniform resource identifier, and use this reference as a means of retrieving the proxy account credential data. Further, retrieved credential data may be sent from an external source, such as an identity management system or cloud computing system, as a permanent or temporary credential data, such as a request-based or session-based token, which is used to access the one or more proxy account accounts. Alternatively, proxy account credential data may be one or more physical attributes of hardware, or connected or associated hardware, and may obtained using the features of the underlying operating system or device drivers. Moreover, obtaining proxy account credential data may consist of a combination of the above, where a computer process constructs the credential data from data obtained from more than one source.

For example, a computer process may access credential data stored on a USB flash drive attached to the computer PC or workstation. Moreover, this credential data may be encrypted, and decryption may be performed by the computer process using data such as a decryption key, which may be obtained from non-persistent memory having been obtained earlier from user input. Additional credential data may be obtained from electronically accessing an identity management system over a network, using session-based tokens stored on the computer PC or workstation from previous authentication to the identity management system, and accessible to the computer process.

In one embodiment, a computer process includes obtaining proxy account credential data that includes at least one of the following types of authentication data for accessing at least one proxy account accounts associated with the one or more cloud accounts of the cloud computing system, the at least one proxy account including at least proxy credential data and access to at least one provisioning policy, the at least one provisioning policy including one or more provisioning constraints with respect to provisioning the one or more computing resources which one or more provisioning constraints are not present in the one or more cloud accounts: username, password, Public Key Infrastructure (PKI) certificate, RSA token, biometric information, time-based token, or a combination of any of the foregoing at 406.

For example, the computer PC or workstation 101 or 1101 or 1201 or 213 may obtain proxy credential data for accessing one proxy account accounts associated with the one or more cloud accounts of the cloud computing system 103 or 1103 or 1203 or 200 (e.g., from a user authentication store containing proxy credential data 1105, or proxy account provisioning APIs). This proxy credential data obtained allows subsequent authorization to the proxy account provisioning APIs, and as such includes at least the type or types of authentication data accepted by these APIs.

In certain embodiments, the proxy account credential data may include a username, which may be selected by a user, assigned randomly by a computer process, or assigned by a computer process based on criteria pertaining to the user, account, or other data that is deemed relevant. Additionally, the proxy account credential data may include a password, which may be selected by a user, assigned randomly by a computer process, or assigned by a computer process based on criteria pertaining to the user, account, or other data that is deemed relevant. Knowledge of a username-password combination is taken by the APIs as establishing authentication as a user for accessing the one or more proxy account accounts.

Alternatively, the proxy account credential data may include a Public Key Infrastructure (PKI) certificate, where a public-private key-pair is generated by a computer process, and knowledge of the private key is required to asymmetrically sign data. The data signature can be validated by the public key; this authenticates knowledge of the private key, and this knowledge is taken by the APIs as establishing authentication as a user for accessing the one or more proxy accounts.

Alternatively, a time-based token may be provided as authentication data. This token may be generated by the cloud computing system or a trusted third party. The token may expire at a certain time, after a certain duration of idleness, or after a certain number of uses.

Alternatively, an RSA device or similar may be provided which generates tokens, which are required as authentication data. This is generally, but not necessarily, used in combination with another kind of authentication as part of a multi-factor authentication technique.

Alternatively, biometric data may be provided as authentication data. This is generally, but not necessarily, used in combination with another kind of authentication as part of a multi-factor authentication technique.

Alternatively, the proxy account credential data may include a time-stamped token such as a ticket-granting ticket, which is obtained after authentication to a ticket-granting service by some means such as described above. The ticket-granting ticket can be used to generate ticket and session keys, and this ticket and/or keys are taken by the APIs as establishing authentication as a user for accessing the one or more proxy accounts. As an example of such an embodiment, the Kerberos protocol may be supported.

For example, the computer process may obtain a username and password, which are sent to the cloud computing system as authentication data. If authenticated, the cloud computing system returns a time-based token, which is valid for several minutes. This time-based token may be sent with subsequent requests, which authenticates these subsequent requests to the proxy account provisioning APIs.

In one embodiment, a computer process includes obtaining proxy account credential data for accessing one or more cloud accounts of a cloud computing system having one or more of the following types of computing resources available to one of more client machines for provisioning: hardware, virtual machine, storage, internet connectivity, software application, a database, a web application, network, application, service, container, or script at 408.

For example, the computer PC or workstation 101 or 1101 or 1201 or 213 may obtain proxy account credential data for accessing one or more proxy accounts of the cloud computing system 103 or 1103 or 1203 or 200 (e.g., from proxy account store or proxy account provisioning APIs). The cloud computing system, using the capabilities in the cloud resource provisioning APIs 211, authenticated using a cloud account linked to the one or more proxy accounts, can provision physical hardware 201, virtual machines 202, operating systems 203, applications such as batch applications 209, application databases 208, SaaS applications 207, serverless applications 205, web applications 206, and other such physical infrastructure or software applications as may be available for provisioning.

A client machine, such as a customer PC or workstation 213, can create requests to be submitted to the cloud environment 200 to obtain proxy account credential data for accessing one or more proxy accounts of the cloud environment 200.

The client machine may include a server, desktop, laptop, mobile device, wearable device, smartphone, tablet, node, or the like, such that the machine has the capacity to request and obtain the credential data to access the one or more proxy accounts of the cloud environment.

The client machine may constitute more than one device working in combination to provide the required capacity to request and obtain the credential data to access the one or more proxy accounts of the cloud environment.

The client machine may include specialized hardware, such as a smart watch or virtual reality glasses, which may not in themselves have the required capacity to request and obtain the credential data to access the one or more proxy accounts of the cloud environment, but can be used in combination with other devices.

A client machine, such as a customer PC or workstation 213, can create requests to be submitted to the cloud environment 200 with credential data for accessing one or more proxy accounts of the cloud environment 200.

The client machine may include a server, desktop, laptop, mobile device, wearable device, smartphone, tablet, node, or the like, such that the machine has the capacity to use the credential data to access the one or more proxy accounts of the cloud environment.

The client machine may constitute more than one device working in combination to provide the required capacity to use the credential data to access the one or more proxy accounts of the cloud environment.

The client machine may include specialized hardware, such as a smart watch or virtual reality glasses, which may not in themselves have the required capacity to use the credential data to access the one or more proxy accounts of the cloud environment, but can be used in combination with other devices.

A client machine, such as a customer PC or workstation 213, can create requests to be submitted to the cloud environment 200 with credential data for accessing one or more proxy accounts of the cloud environment 200, having computing resources provisioned to client machines.

The client machine may include a server, desktop, laptop, mobile device, wearable device, smartphone, tablet, node, or the like, such that the machine has the capacity to be provisioned with computing resources.

The client machine may constitute more than one device working in combination to provide the required capacity to be provisioned with computing resources.

The client machine may include specialized hardware, such as a smart watch or virtual reality glasses, which may not in themselves have the required capacity to be provisioned with the computing resource, but can be used in combination with other devices.

A client machine, such as a customer PC or workstation 213, can create requests to be submitted to the cloud environment 200 with proxy credential data for accessing one or more proxy accounts of the cloud environment 200, having computing resources provisioned to client machines, after which the computing resources are accessible to the client machine.

The client machine may include a server, desktop, laptop, mobile device, wearable device, smartphone, tablet, node, or the like, such that the machine has the capacity to access the computing resources.

The client machine may constitute more than one device working in combination to provide the required capacity to access the computing resources.

The client machine may include specialized hardware, such as a smart watch or virtual reality glasses, which may not in themselves have the required capacity to be access the computing resource, but can be used in combination with other devices.

A mobile phone may use its computing, networking and storage capabilities to construct, send, and receive requests of a cloud computing system. Proxy credential data which is obtained from the cloud computing system may be saved to persistent storage. The cloud computing system may provision computing resources to a customer PC or workstation, and the provisioned resource is then accessible to the mobile phone.

Similarly, a networked PC, workstation or tablet may use its computing, networking and storage capabilities to construct, send, and receive requests of a cloud computing system. Proxy account credential data which is obtained from the cloud computing system may be saved to persistent storage. The cloud computing system may provision computing resources, and the provisioned resource is then accessible to the networked PC, workstation or tablet.

In another embodiment, a wearable computer device such as a smart watch or VR google may construct a request from user input, and leverage a supporting device such as a mobile phone, networked PC, workstation or tablet to construct, send, and receive requests of a cloud computing system. Proxy account credential data which is obtained from the cloud computing system may be saved to persistent storage. The cloud computing system may provision computing resources, and the provisioned resource is then accessible to the wearable device.

For example, a user activates an icon on their watch, and speaks a passphrase and request into the watch's microphone. The phrase and voice pattern are recorded and sent to the user's mobile phone using Bluetooth. The mobile phone verifies the phrase and voice patterns, and sends a request to a cloud computing system to obtain proxy account credential data. The mobile phone uses this credential data to request for computing resources to be provisioned to a remote server. The computing resources on the remote server are then accessible to the user's watch.

In one embodiment, a computer process includes establishing by the cloud computing system at least one proxy account associated with the one or more cloud accounts of the cloud computing system, the at least one proxy account including at least proxy credential data and access to at least one provisioning policy, the at least one provisioning policy including one or more provisioning constraints with respect to provisioning the one or more computing resources which one or more provisioning constraints are not present in the one or more cloud accounts.

A process or application in a cloud computer system, such as cloud account provisioning APIs 210, creates and saves to persistent storage a new proxy account, associates the proxy account with a cloud account, and associates the proxy account with a provisioning constraint.

In one embodiment, a computer process includes establishing by at least one proxy system at least one proxy account associated with the one or more cloud accounts of the cloud computing system, the at least one proxy account including at least proxy credential data and access to at least one provisioning policy, the at least one provisioning policy including one or more provisioning constraints with respect to provisioning the one or more computing resources which one or more provisioning constraints are not present in the one or more cloud accounts.

An application proxy 204, which may exist on a cloud environment 200, creates and saves to persistent storage a new proxy account, associates the proxy account with a cloud account, and associates the proxy account with a provisioning constraint.

In one embodiment, a request to create a cloud account is received. In fulfilling the request for the creation of the cloud account, a process or application in a cloud computer system may create one or more proxy accounts, and one or more provisioning policies, associated with the cloud account.

In another embodiment, a request to create provisioning constraints is received. In fulfilling the request for the creation of the provisioning constraints, a system may create one or more proxy accounts, and one or more cloud accounts associated with the proxy account.

In another embodiment, a request to create provisioning constraints and a cloud account are received. In fulfilling the request for the creation of the provisioning constraints and a cloud account, a process or application in a cloud computer system may create one or more proxy accounts, associated with the provisioning constraints and cloud account.

In another embodiment, upon the installation of an application in a cloud computer system, such as the installation of a proxy application, a process or application in a cloud computer system checks for existing cloud accounts in the cloud computer system. The application or process in a cloud computer system creates one or more proxy accounts and provisioning constraints, and associates the existing cloud accounts with the new one or more proxy accounts.

In another embodiment, a request to provide one or more proxy accounts and/or one or more provisioning constraints is received by a process or application in a cloud computer system. The process or application in the cloud computer system creates one or more proxy account and provisioning constraints, and associates new or existing cloud accounts with the new one or more proxy accounts.

Alternatively, instead of associating one cloud account with one or more proxy accounts policies, a proxy account may be associated with one or more cloud accounts.

Alternatively, instead of associating a cloud account with one or more proxy accounts, a cloud account can be associated with one or more provisioning policies.

Alternatively, instead of associating a cloud account with one or more provisioning policies, a provisioning policy may be associated with one or more cloud accounts.

For example, a user sends a request to create a new cloud account to a cloud account provisioning API. On creating the cloud account, the cloud account provisioning APIs, either directly or by request to an application proxy, create a new proxy account for the user who requested the new cloud account, create a new proxy account for the supervisor of the user who requested the new cloud account, create a default provisioning policy requiring both proxy accounts to request any changes to the provisioning policy, and associates the new proxy accounts and provisioning policy with the new cloud account. Credentials for the first proxy account are sent to the user who requested the new cloud account. Credentials for second proxy account are sent to the user's supervisor. Alternatively, if a proxy account already exists for the user's supervisor, the second proxy account is not created, and instead the existing proxy account is linked to the new cloud account.

For example, Alice needs to be able to provision applications into a cloud environment, and her manager Zoe needs to approve Alice's provisioning requests before they are actioned. Zoe does not need to be able to provision applications into the cloud environment—only approve requests submitted by Alice. Granting direct access to a cloud account to Alice or Zoe would give them the ability to perform actions that are not required. Instead, Alice and Zoe are given access to proxy accounts, associated with one or more provisioning policies which describe the actions they can perform, and at least one proxy account associated with a cloud account able to provision applications into a cloud environment.

In one embodiment, Alice creates a proxy account, associated with a provisioning policy granting the ability to provision applications into a cloud environment depending on approval from Zoe's proxy account, and associated with one or more cloud accounts able to provision applications into a cloud environment. On receiving a request from Alice to provision an application into a cloud environment, a notification is sent to Zoe, for example as an email to the email address associated with Zoe's proxy account. After both the request from Alice describing the application to be provisioning, and a response from the notification or a separate request from Zoe indicating approval from Zoe, the request for provisioning an application into the cloud environment is submitted using the one or more cloud accounts associated with Alice's proxy account and the application is provisioned.

In another embodiment, Alice creates a proxy account, associated with a provisioning policy granting the ability to provision applications into a cloud environment depending on approval from Zoe's proxy account, but not associated with any cloud account able to provision applications into a cloud environment. On receiving a request from Alice to provision an application into a cloud environment, a notification is sent to Zoe, for example as an email to the email address associated with Zoe's proxy account. After both the request from Alice describing the application to be provisioning, and a response from the notification or a separate request from Zoe indicating approval from Zoe, the request for provisioning an application into the cloud environment is submitted using the one or more cloud accounts associated with Zoe's proxy account and the application is provisioned.

In another embodiment, provisioning policies may grant the ability to provision applications into a cloud environment, and the provisioning policy may detail the network connections which are available to deployed applications, or the virtual networks which are available to be created. These network connections or virtual networks may enable applications access to data stores or APIs. Some may be available for any application deployed, others unavailable, and others requiring approval.

For example, Alice has a proxy account, associated with a provisioning policy which grants the ability to create a database and a web application, and a virtual network connecting a database and a web application. Bob works in a different organization to Alice, and owns a database which Alice's web application needs to access. Bob's proxy account is associated with a provisioning policy that grants him the ability to approve the creating of a virtual network connecting to this database. The provisioning policy associated with Alice's proxy account grants the ability to create a virtual network connecting her web application with Bob's database, pending approval from Bob's proxy account. If Bob approves the request, then Alice's web application is connected to both her database, and Bob's database, through the respective virtual networks.

In other example, Alice is developing APIs which she wants to share in a controlled manner to other applications and organizations. The provisioning policy associated with her proxy account allows her to deploy APIs into a cloud environment, and allows her APIs to access other local or approved API, or to configure the APIs to be accessed by other local or approved APIs. If she wishes to access other APIs or make her API available to other APIs (by, for example, opening a firewall or provisioning a proxy), then her provisioning policy requires that the provisioning request be approved. Such an approval may also include or initiate reviews, cost-sharing, monitoring activities, and other API governance procedures as appropriate.

In one embodiment, a computer process includes establishing by the cloud computing system at least one proxy account associated with the one or more cloud accounts of the cloud computing system, the at least one proxy account including at least proxy credential data and access to at least one provisioning policy, the at least one provisioning policy including one or more provisioning constraints with respect to provisioning the one or more computing resources which one or more provisioning constraints are not present in the one or more cloud accounts.

In one embodiment, a computer process includes establishing by at least one proxy system at least one proxy account associated with the one or more cloud accounts of the cloud computing system, the at least one proxy account including at least proxy credential data and access to at least one provisioning policy, the at least one provisioning policy including one or more provisioning constraints with respect to provisioning the one or more computing resources which one or more provisioning constraints are not present in the one or more cloud accounts.

For example, the customer PC or workstation 213 can create a request from user input and persistent storage, containing data including proxy credential data, reference to one or more cloud accounts, and one or more provisioning policies, sending the request to the cloud environment 200 over a network 212. The application proxy 204 receives the request and creates in persistent storage data for a new proxy account containing the proxy credential data in a user authentication store 1105, creates in persistent storage data for the at least one or more provisioning policies in a cloud resource provisioning policy store 1107, associates the proxy account with the one or more cloud accounts in the cloud account store 1110, and associates the proxy account with the one or more provisioning policies. A response is constructed and returned via the network 212 to the customer PC or workstation 213.

In one embodiment, the request is sent to one proxy system, which stores to local persistent storage data for a new proxy account, containing the proxy credential data, creates in persistent storage data for the at least one or more provisioning policies, associates the proxy account with the one or more cloud accounts, and associates the proxy account with the one or more provisioning policies.

In another embodiment, the request is sent to a broker system, which sends to one or several proxy systems, each of which persists storage data and/or associates one or more account or policy.

In another embodiment, the proxy system sends requests via an API or other means to other systems, which persists storage data and/or associates one or more account or policy.

For example, a request to establish a proxy account is sent to a proxy system, which receives credential data for the proxy account, a reference to one or more provisioning policies, and a reference to one or more cloud accounts. The credential data for the proxy account is persisted to local storage. The reference to the proxy account, with the reference to the one or more provisioning policies, is sent to a policy proxy system, which persists this association. The reference to the proxy account, with the reference to the one or more cloud accounts, is sent to an identity management system, which stores this association.

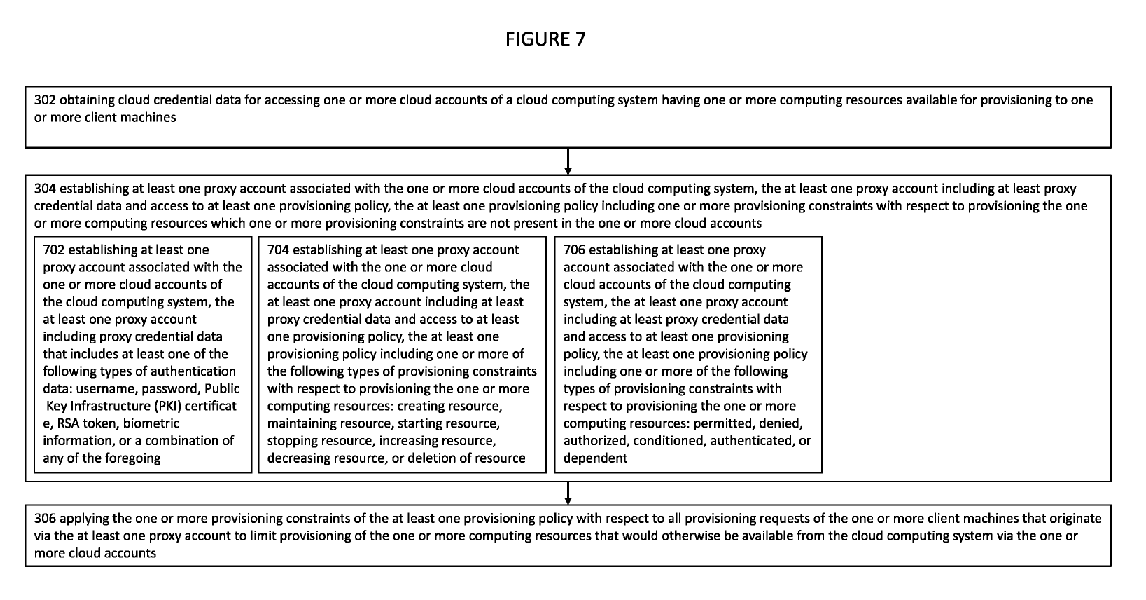

FIG. 7 is a flow diagram of computer process, in accordance with an embodiment of the invention.

In one embodiment, a computer process includes establishing at least one proxy account associated with the one or more cloud accounts of the cloud computing system, the at least one proxy account including proxy credential data that includes at least one of the following types of authentication data: username, password, Public Key Infrastructure (PKI) certificate, RSA token, biometric information, or a combination of any of the foregoing at 702.

The customer PC or workstation 213 can create a request from user input and persistent storage, sending the request to the cloud environment 200 over a network 212. This request may contain proxy account credential data. The application proxy 204 receives the request and creates in persistent storage data for a new proxy account in a use authentication store 1105, including the proxy account credential data. A response is constructed and returned via the network 212 to the customer PC or workstation 213.

In one embodiment, the credential data is a secret token, such as a string of letters, numbers, etc.

In another embodiment, the credential data is biometric information which is collected at the PC or workstation, or attached or networked device, or loaded from an attached or networked device.

In another embodiment, the credential data is a username and password, which may be selected by a user or generated by a computer process.

In another embodiment, the credential data is a Public Key Infrastructure (PKI) certificate, which may be provided by a user or generated or loaded by a computer process.

In another embodiment, the credential data may be a one-time token, which may be generated by a device or computer process, such as an RSA device.

In another embodiment, the credential data may be a method of generating a one-time token which is sent to a user's device such as a mobile phone, or a user's email address, or some other device or account with access such that it is sufficiently restricted, the one-time token being used in combination with the method to provide credential data.

In another embodiment, a combination of the above kinds of credential data are used.

In each embodiment, credential data may be provided or sourced from the customer PC or workstation, or user or process there, or it may be provided or sourced from a server, cloud environment, or application proxy, or user or process there.

For example, a mobile phone has an attached device which is able to read a fingerprint. A user has their fingerprint scanned, and sends a request from the mobile phone, over a WIFI network and then the internet, to a server. There, a process generates a password, creates a proxy account, associates the credential data of the fingerprint and password to the proxy account, and send the password back to the mobile phone, to be read by the user.

In one embodiment, a computer process includes establishing at least one proxy account associated with the one or more cloud accounts of the cloud computing system, the at least one proxy account including at least proxy credential data and access to at least one provisioning policy, the at least one provisioning policy including one or more of the following types of provisioning constraints with respect to provisioning the one or more computing resources: creating resource, maintaining resource, starting resource, stopping resource, increasing resource, decreasing resource, or deletion of resource at 704.

A customer PC or workstation 213 can create a request from user input and persistent storage, containing one or more provisioning policies, sending the request to the cloud environment 200 over a network 212. The application proxy 204 receives the request and creates in persistent storage data for a new proxy account in a user authentication store 1105, and associates the proxy account with the one or more provisioning policies in the cloud resource provisioning policy store 1107. A response is constructed and returned via the network 212 to the customer PC or workstation 213.

In one embodiment, the one or more provisioning policies contain a policy which allows the creation of a resource on the cloud environment, such as the allocation of hardware, the provisioning of a virtual machine, the creation of a network, the creation of an application server, the deployment of an application, or the installation of a script.

In another embodiment, the one or more provisioning policies contain a policy which allows the maintenance of a resource on the cloud environment, such as changing configuration, contents, data, code, status, status of various components, or other attribute of the resource.

In another embodiment, the one or more provisioning policies contain a policy which allows the starting of a resource on the cloud environment. For example, a policy may allow a web application server such as Tomcat or a JEE server, deployed onto the cloud environment, to be started.

In another embodiment, the one or more provisioning policies contain a policy which allows the stopping of a resource on the cloud environment. For example, a policy may allow a web application server such as Tomcat or a JEE server, deployed onto the cloud environment, to be stopped.

In another embodiment, the one or more provisioning policies contain a policy which allows the increase of computation or other resource to a resource which is deployed on the cloud environment. For example, a policy may allow a web application server such as Tomcat or a JEE server, deployed onto the cloud environment, to have more CPUs allocated.

In another embodiment, the one or more provisioning policies contain a policy which allows the decrease of computation or other resource to a resource which is deployed on the cloud environment. For example, a policy may allow a web application server such as Tomcat or a JEE server, deployed onto the cloud environment, to have less CPUs allocated.

In another embodiment, the one or more provisioning policies contain a policy which allows the deletion of a resource which is deployed on the cloud environment.

In another embodiment, the one or more provisioning policies contain policies which allow for a combination of the above.

For example, a proxy account is established, with associated policies allowing requests from this proxy account to start or stop a tomcat web application server, containing a web application, which has been previously deployed onto a cloud environment.

In one embodiment, a computer process includes establishing at least one proxy account associated with the one or more cloud accounts of the cloud computing system, the at least one proxy account including at least proxy credential data and access to at least one provisioning policy, the at least one provisioning policy including one or more of the following types of provisioning constraints with respect to provisioning the one or more computing resources: permitted, denied, authorized, conditioned, authenticated, or dependent at 706.

A customer PC or workstation 213 can create a request from user input and persistent storage, containing one or more provisioning policies, sending the request to the cloud environment 200 over a network 212. The application proxy 204 receives the request and creates in persistent storage data for a new proxy account, and associates the proxy account with the one or more provisioning policies. A response is constructed and returned via the network 212 to the customer PC or workstation 213.

In one embodiment, the one or more provisioning policies contain a policy which permits one or more actions to take place.

In another embodiment, the one or more provisioning policies contain a policy which denies permission for one or more actions to take place.

In another embodiment, the one or more provisioning policies contain a policy which allows authorization of one or more actions, for an action which has been submitted but requires authorization, or to authorize a future action.

In another embodiment, the one or more provisioning policies contain a policy to give permission for one or more actions to take place, dependent on a previous, concurrent, or subsequent event, state, action, or policy. For example, a policy may give permission to deploy a version of a web application dependent on the condition that an older version of this web application has already been deployed.

In another embodiment, the one or more provisioning policies contain a policy to give conditional permission for one or more actions to take place, based on a previous, concurrent, or subsequent event, state, action or policy. For example, a policy may give permission to deploy a version of a web application conditional on this version being the latest version of the web application. If a more recent version has been deployed, or is being deployed, then the deployment does not proceed. If a more recent version is deployed in the future, then the deployment is removed.

In another embodiment, the one or more provisioning policies contain a policy which allows one or more actions to take place based on previous or subsequent authentication of credentials.

For example, a proxy account is established, with a resource provisioning policy which permits resource creation requests from this proxy account of scripts loaded from a particular repository, to be run as a serverless application with default hardware usage limitations, and requested hardware usage restricted to a given range, dependent on a correct reply to an authentication challenge sent to another proxy account.

For example, Alice has a proxy account associated with a provisioning policy A which allows web applications to be deployed, and further gives permission to start or stop a web application which has been deployed from her proxy account. Bob has a proxy account associated with the same provisioning policy A, and associated with another provisioning policy B which gives permission to start or stop any web application. Carol has a proxy account associated with provisioning policy B. Debbie has a proxy account associated with provisioning policy A, and associated with provisioning policy D, which disallows starting and stopping web applications, and associated with provisioning policy E, which requires that her requests require approval. Fred has a provisioning policy F, which allows him to approve requests from provisioning policy E. In this example, Alice and Bob can deploy web applications, Alice can stop and start web applications which she has deployed, and Bob and Carol can stop and start any web application. While Debbie can request for a web application to deployed, this request requires approval from Fred, and she cannot start or stop web applications.

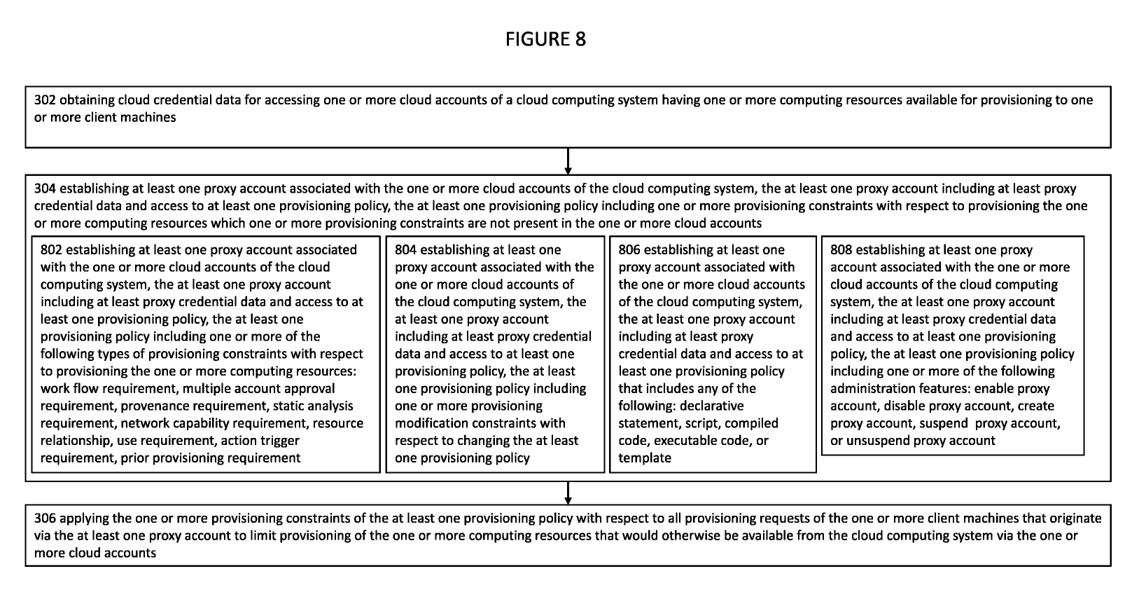

FIG. 8 is a flow diagram of computer process, in accordance with an embodiment of the invention.

In one embodiment, a computer process includes establishing at least one proxy account associated with the one or more cloud accounts of the cloud computing system, the at least one proxy account including at least proxy credential data and access to at least one provisioning policy, the at least one provisioning policy including one or more of the following types of provisioning constraints with respect to provisioning the one or more computing resources: work flow requirement, multiple account approval requirement, provenance requirement, static analysis requirement, network capability requirement, resource relationship, use requirement, action trigger requirement, prior provisioning requirement at 802.

A computer process such as an application proxy 204 in a cloud environment 200 persists to local storage a proxy account containing at least proxy credential data, persists an association between the proxy account and one or more cloud accounts of the cloud computing system, and persists the association between the proxy account and at least one provisioning policy.

In one embodiment, a provisioning policy contains a provisioning constraint requiring a work flow, such as previous, subsequent or concurrent actions occurring.

In another embodiment, a provisioning policy contains a provisioning constraint requiring multiple account approval, which may be one or more specific accounts, or combination of accounts, or combination of accounts under different circumstances.

In another embodiment, a provisioning policy contains a provisioning constraint requiring specific provenance. For example, a request may need to originate from a particular machine or network, references contained in a request may be limited to particular locations or patterns, requests or references contain in a request may need to have a particular combination of source, routing, time, destination, and/or other attributes of the request.

In another embodiment, a provisioning policy contains a provisioning constraint requiring static analysis, such as the requirement to perform tests on the request, environment and/or application proxy, to ensure it conforms to certain requirements, such as length, content types, white-listed or black-listed content or patterns, comparison to known or generated content or patterns, or submission to an API.

In another embodiment, a provisioning policy contains a provisioning constraint requiring network capability, such as an open connection to one or more networks or resources, a blocked connection to one or more networks or resources, or a partial connection to one or more networks or resources, or a connection to one or more networks or resources with characteristics, such as topography, location, bandwidth or performance.

In another embodiment, a provisioning policy contains a provisioning constraint requiring a relationship with a resource, such as a similarity or difference in configuration, including location, access, or timing of activity.

In another embodiment, a provisioning policy contains a provisioning constraint requiring use, such as the resource is to be used in a certain manner, with access or patterns of access by users or locations.

In another embodiment, a provisioning policy contains a provisioning constraint requiring an action trigger, such as an authentication, time, API call, web page access, provision or de-provision of a resource, starting or stopping of a resource, activation or inactivation of a resource or user, receipt of a token, or availability or price-point for a resource such as CPU, memory, storage, or network.

In another embodiment, a provisioning policy contains a provisioning constraint requiring one or more prior provisionings, such that a serial or parallel sequence of dependent provisionings is followed, or that the current provisioning approval is reversed if one or more subsequent provisionings does not occur.

In another embodiment, a provisioning policy contains a provisioning constraint requiring a combination of the above.

For example, a provisioning constraint allows for a reference to a directory in a source code repository, code from which will be deployed as a serverless application in a cloud environment. The constraint requires the code pass a source code analysis, such as a static application security test, that an API call checking for sufficient funds in the cloud subscription for the cloud environment finds more than a given minimum balance, and that an authentication challenge to a proxy account linked to the provisioning constraint as a authorizer is answered with the correct authorization token.

In one embodiment, a computer process includes establishing at least one proxy account associated with the one or more cloud accounts of the cloud computing system, the at least one proxy account including at least proxy credential data and access to at least one provisioning policy, the at least one provisioning policy including one or more provisioning modification constraints with respect to changing the at least one provisioning policy at 804.

A computer process such as an application proxy 204 in a cloud environment 200 persists to local storage a proxy account containing at least proxy credential data, persists an association between the proxy account and one or more cloud accounts of the cloud computing system, and persists the association between the proxy account and at least one provisioning policy.

In one embodiment, a provisioning policy contains a provisioning constraint referring to the actions available to change the provisioning constraints contained in one or more provisioning policies.

In another embodiment, a provisioning policy contains a provisioning constraint referring to the actions available to change the provisioning constraints contained in one or more provisioning policies, such that the provisioning constraints in one or more provisioning policies are no longer applied with respect to provisioning computer resources or with respect to changing provisioning constraints in provisioning policies or with respect to other constraints that may be present in provisioning policies.

In another embodiment, a provisioning policy contains a provisioning constraint referring to the actions available to change the provisioning constraints contained in one or more provisioning policies, such that new provisioning constraints are applied in one or more provisioning policies with respect to provisioning computer resources or with respect to changing provisioning constraints in provisioning policies or with respect to other constraints that may be present in provisioning policies.

In another embodiment, a provisioning policy contains a provisioning constraint referring to the actions available to change the provisioning constraints contained in one or more provisioning policies, such that the provisioning constraints in one or more provisioning policies are altered with respect to provisioning computer resources or with respect to changing provisioning constraints in provisioning policies or with respect to other constraints that may be present in provisioning policies.

In another embodiment, a provisioning policy contains a provisioning constraint referring to the actions available to add or remove a provisioning policy.

In another embodiment, a provisioning policy contains a provisioning constraint referring to the actions available to associate or disassociate a provisioning policy with a proxy or cloud account.

For example, a provisioning policy contains permissions, including the permission for an authenticated user of an associated proxy account to create a new provisioning policy, which may contain any of the permissions contained within any provisioning policies associated with the proxy account, and associate this new provisioning policy to a proxy account.

In another example, a provisioning policy may allow a user authenticating with an associated proxy account to add the requirement of authorization by this proxy account to provisioning policies that might be selected from a list of existing provisioning policies.

In one embodiment, a computer process includes establishing at least one proxy account associated with the one or more cloud accounts of the cloud computing system, the at least one proxy account including at least proxy credential data and access to at least one provisioning policy that includes any of the following: declarative statement, script, compiled code, executable code, or template at 806.

A computer process such as an application proxy 204 in a cloud environment 200 persists to local storage a proxy account containing at least proxy credential data, persists an association between the proxy account and one or more cloud accounts of the cloud computing system, and persists the association between the proxy account and at least one provisioning policy.

In one embodiment, a provisioning policy includes one more declarative statements which can be interpreted by the application proxy when applying the constraints of the provisioning policy. For example, the declarative statement “VM: DEPLOY: ANY” might indicate that the provisioning policy allows any virtual machine image to be deployed. A declarative statement may be in XML, YML, JSON, or similar formal syntax, a natural language, or a subset of a natural language.

In another embodiment, a provisioning policy includes one more scripts which can be interpreted by the application proxy, run by the application proxy against a request, or incorporated into the application proxy, when applying the constraints of the provisioning policy. A script may be in an established scripting language such as Javascript, or may be a domain specific language created for the domain of provisioning policies, constraints, or similar, or a scripting language created for the application proxy, or a scripting language created for the cloud computing system.

In another embodiment, a provisioning policy includes compiled code which can be interpreted by the application proxy, run by the application proxy against a request, or incorporated into the application proxy, when applying the constraints of the provisioning policy.

In another embodiment, a provisioning policy includes executable code which can be interpreted by the application proxy, run by the application proxy against a request, or incorporated into the application proxy, when applying the constraints of the provisioning policy.

In another embodiment, a provisioning policy includes a template which can be interpreted by the application proxy, run by the application proxy against a request, or incorporated into the application proxy, when applying the constraints of the provisioning policy.

In another embodiment, a provisioning policy includes the ability to be parameterized or extended with information from the request, previous requests, or the environment.

For example, a provisioning policy contains JavaScript code, which accepts structured request as input. The application proxy, upon receiving a correctly structured request from a client, calls the JavaScript code with the request as input, and receives a result indicating whether the request fulfils the requirements of the provisioning policy.

In one embodiment, a computer process includes establishing at least one proxy account associated with the one or more cloud accounts of the cloud computing system, the at least one proxy account including at least proxy credential data and access to at least one provisioning policy, the at least one provisioning policy including one or more of the following administration features: enable proxy account, disable proxy account, create proxy account, suspend proxy account, or unsuspend proxy account at 808.

A computer process such as an application proxy 204 in a cloud environment 200 persists to local storage a proxy account containing at least proxy credential data, persists an association between the proxy account and one or more cloud accounts of the cloud computing system, and persists the association between the proxy account and at least one provisioning policy.

In one embodiment, a provisioning policy contains a provisioning constraint which allows a request to enable a proxy account.

In another embodiment, a provisioning policy contains a provisioning constraint which allows a request to disable a proxy account.

In another embodiment, a provisioning policy contains a provisioning constraint which allows a request to create a proxy account.

In another embodiment, a provisioning policy contains a provisioning constraint which allows a request to suspend a proxy account.

In another embodiment, a provisioning policy contains a provisioning constraint which allows a request to unsuspend a proxy account.

In another embodiment, a provisioning policy contains a provisioning constraint which allows a request to associate or disassociate one or more provisioning policies with one or more proxy accounts.

Alternatively, instead of allowing a change to a proxy account, a provisioning policies can disallow, allow with authorization, or allow or disallow conditionally or with dependency.

For example, Alice may request a change to Bob's proxy account, to associate Bob's proxy account with another provisioning policy which would allow Bob's proxy account to deploy web applications to a cloud environment. Alice's proxy account is associated with a provisioning policy which allows this request to be immediately granted, so that Bob's proxy account is now associated with the provisioning policy as requested. Additionally, a notification of this request and association is sent to Zoe, who can rescind the association of Bob's proxy account with this provisioning policy.

In another embodiment, a provisioning policy contains a provisioning constraint which allows a combination of the above actions a proxy account.

For example, a provisioning policy may allow a user authenticating with an associated proxy account to associate a provisioning policy selected from a list of existing provisioning policies to a proxy account selected from a list of existing proxy account, with the newly associated provisioning policy allowing the associated proxy accounts the provision a particular application into a cloud environment.

For example, a provisioning policy may allow a user authenticating with an associated proxy account to disable proxy accounts associated with a provisioning policy selected from a list of existing provisioning policies.

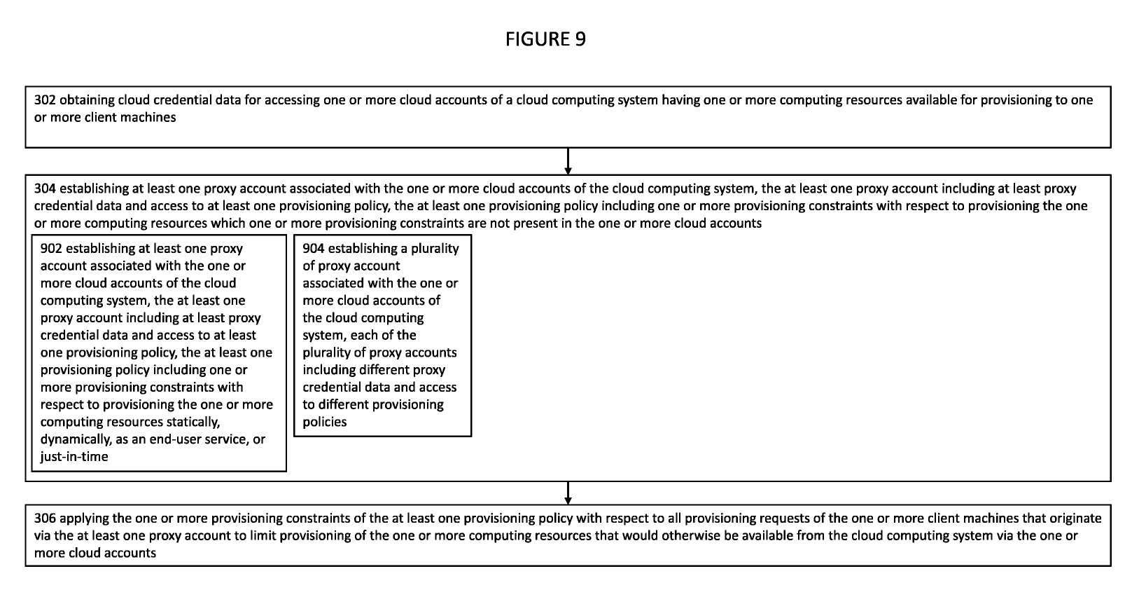

FIG. 9 is a flow diagram of computer process, in accordance with an embodiment of the invention.

In one embodiment, a computer process includes establishing at least one proxy account associated with the one or more cloud accounts of the cloud computing system, the at least one proxy account including at least proxy credential data and access to at least one provisioning policy, the at least one provisioning policy including one or more provisioning constraints with respect to provisioning the one or more computing resources statically, dynamically, as an end-user service, or just-in-time at 902.

A computer process such as an application proxy 204 in a cloud environment 200 persists to local storage a proxy account containing at least proxy credential data, persists an association between the proxy account and one or more cloud accounts of the cloud computing system, and persists an association between the proxy account and at least one provisioning policy. The provisioning policy persisted contains provisioning constraints with respect to provisioning the one or more computing resources statically, dynamically, as an end-user service, or just-in-time, the constraints being applied to provisioning requests initiated from the proxy account.

In one embodiment, a provisioning constraint in the at least one provisioning policy provisions one or more computing resources statically, where computing resources are provisioned as requested at the time of the request, and remain in place until a request is received to remove the computing resources.

In another embodiment, a provisioning constraint in the at least one provisioning policy provisions one or more computing resources dynamically, where computing resources are provisioned over time, according to criteria specified in the request, provisioning policy, system defaults, attributes of a local or remote system, results of a call to a local or remote API, or other data which is obtained. The computing resources are provisioned or de-provisioned in response to changes in these criteria or data.

For example, a system default for an application may be that the number of cores allocated to the application may vary from 2 to 100. An application monitors the application's CPU usage and depending on the load on the cores, varies the number of cores assigned to the application. A provisioning policy for the application may allow a request to increase or decrease the number of cores, or the criteria by which the monitoring application increases or decreases the number of cores. Further, a provisioning policy may provide its own defaults, which apply if not specified in the request.

In another example, the provisioning policy for an application may contain the details for the provisioning of a new monitoring application to monitor the application, and vary the number of cores according to criteria in the request or the provisioning policy.

In another embodiment, a provisioning constraint in the at least one provisioning policy provisions one or more computing resources as an end-user service, where computing resources are provisioned or de-provisioned on request from the end-user service which has been provided for the provisioning and/or de-provisioning of the computing resources, as specified in the provisioning constraint.

In another embodiment, a provisioning constraint in the at least one provisioning policy provisions one or more computing resources just-in-time, where computing resources are provisioned or de-provisioned as needed in response to the demand places on the computing resources by consumers of the computing resources.

For example, a resource may be provisioning as a cluster. A system default for an application may be that the number of instances of the application in a cluster that is provisioned may vary from 2 to 10. An application monitors the cluster and depending on usage, varies the number of instances in the cluster. A provisioning policy for the application may allow a request to increase or decrease the number of instances, or the criteria by which the monitoring application increases or decreases the number of instances. Further, a provisioning policy may provide its own defaults, which apply if not specified in the request.

In another example, the provisioning policy for an application may contain the details for the provisioning of a new monitoring application to monitor the cluster, and vary the number of instances according to criteria in the request or the provisioning policy.

In another example, an application is held ready to be provisioned, and is provisioned just-in-time to meet demand, such as a request being received which requires this application. For example, Alice sends a request to an application proxy, for a web application to be provisioned in a cloud environment, which is permitted by the provisioning policy associated with her proxy account. The provisioning policy has the condition that the application will be provisioned when requests are received by the application proxy which require its use; so, for example, if Bob wishes to use a web page which is served by this web application, the request is sent to the application proxy which provisions the web application, as requested by Alice, to serve the web page for Bob.

In another embodiment, a provisioning constraint in the at least one provisioning policy provisions one or more computing resources using a combination of static, dynamic, end-user service and just-in-time provisioning.

For example, a provisioning constraint specifies that a computing resource will be provisioned dynamically and just-in-time. A web application is provisioning initially with a minimal amount of CPU and memory, with these being monitored and increase and decreased as needed to ensure that user demand in being met. Additionally, a web service is regularly called, to ensure that sufficient funds remain to allow for the web application to be provisioned; based on this balance, the amount of computing resource allocated to the web application may be decreased, or the application de-provisioned. Upon sufficient funds becoming available again, the computing resource may be restored to the initial value, or re-provisioned. Further, the amount of computing resource may vary dynamically according to multiple criteria, for example a formula may include the demand for the web application, the funds remaining, and cost of provisioning thus far, to determine the amount of computing resource to be provisioned. For instance, Alice may provision a web application, requesting that 10 cores be allocated to her application, with no regard to cost. The provisioning policy associated with her proxy account would normally allow a provisioning request by Alice, but only under certain cost guidelines, so a constraint is invoked to notify Bob, who is required to approve the request before it will be provisioned. He may approve the request, but decides to add a cost constraint so that the number of cores will be constrained to ensure that cost of provisioning the web application is kept under a daily maximum. In this instance, the web application will be allocated cores dynamically to meet demand, but limited based on forward estimates of costs to ensure that there will be sufficient funds to have at least one core available to the web application without the daily maximum cost being exceeded.

For example, a provisioning constraint specifies that a computing resource will be provisioned dynamically. A web application is provisioning initially with read access to a database. A web service is regularly called, to ensure that permission run the web application and permission to access the database are still allowed. If permission to access to run the web application is removed, then web application will be de-provisioned. If permission to access to the database is removed, then the web application remains provisioned, but its read access to the database is removed.

In one embodiment, a computer process includes establishing a plurality of proxy accounts associated with the one or more cloud accounts of the cloud computing system, each of the plurality of proxy accounts including different proxy credential data and access to different provisioning policies at 904.

A computer process such as an application proxy 204 in a cloud environment 200 persists to local storage several proxy accounts, each containing at least proxy credential data. For each proxy account, the application proxy persists an association between the proxy account and one or more cloud accounts of the cloud computing system. For each proxy account, the application proxy persists an association between the proxy account and at least one provisioning policy.

In one embodiment, the plurality of proxy accounts, while associated with different proxy credential data, are associated with the same cloud account of the cloud computing system.

In another embodiment, the plurality of proxy accounts, while associated with different proxy credential data, are each associated with a different cloud account of the cloud computing system.

In another embodiment, the plurality of proxy accounts, while associated with different proxy credential data, are each associated with zero or more particular cloud accounts of the cloud computing system depending on the authorization requirements of the actions in the one or more associated provisioning policies.

In one embodiment, the plurality of proxy accounts, while associated with different proxy credential data, are associated with the same one or more provisioning policies.

In another embodiment, the plurality of proxy accounts, while associated with different proxy credential data, are each associated with one or more different provisioning policies.

In another embodiment, the plurality of proxy accounts, while associated with different proxy credential data, are each associated with one or more particular provisioning policies depending on the requirements of each proxy account to be authorized to perform particular actions in the cloud environment.

For example, there exists in a cloud computing system two cloud accounts: cloud account P, which has the ability to add resources into the cloud computing system, and cloud account D, which has the ability to delete resources from the cloud computing system. There exists three policies: policy A, which has the constraint of allowing only an approval of a request previously submitted by a proxy account which has policy P; policy P, which has the constraint of allowing only the addition of resources into the cloud computing system, with the requirement that the request be subsequently approved by a proxy account which has policy A; and policy D, which has the constraint of only allowing the deletion of resources from the cloud computing system.

Polly has a proxy account established, which is associated with a provisioning policy P, allowing her to add a new application onto a cloud environment dependent on approval from another proxy account. Alice has a proxy account established, which is associated with a provisioning policy A. Debbie has a proxy account established, which is associated with policy P and D. In this example, the proxy account established for Polly is associated with a cloud account P of the cloud computing system, which has permission to add resources onto the cloud computing system, and the proxy account established for Alice is not associated with a cloud account of the cloud computing system. Alternatively, the proxy account established for Alice may be associated with a cloud account P, and the proxy account established for Polly not associated with a cloud account of the cloud computing system. The proxy account established for Debbie is associated with a cloud account P, and with a cloud account D. Alternatively, the proxy account established for Debbie may be associated with cloud account D, and the proxy account established for Alice associated with cloud account P. In this example, a request for add a new application, from Polly or Debbie, needs to be approved by Alice, before the new application is created in the cloud environment using account P. A request from Debbie to remove a resource will cause it to be removed using account D, and does not need to be approved by Alice.

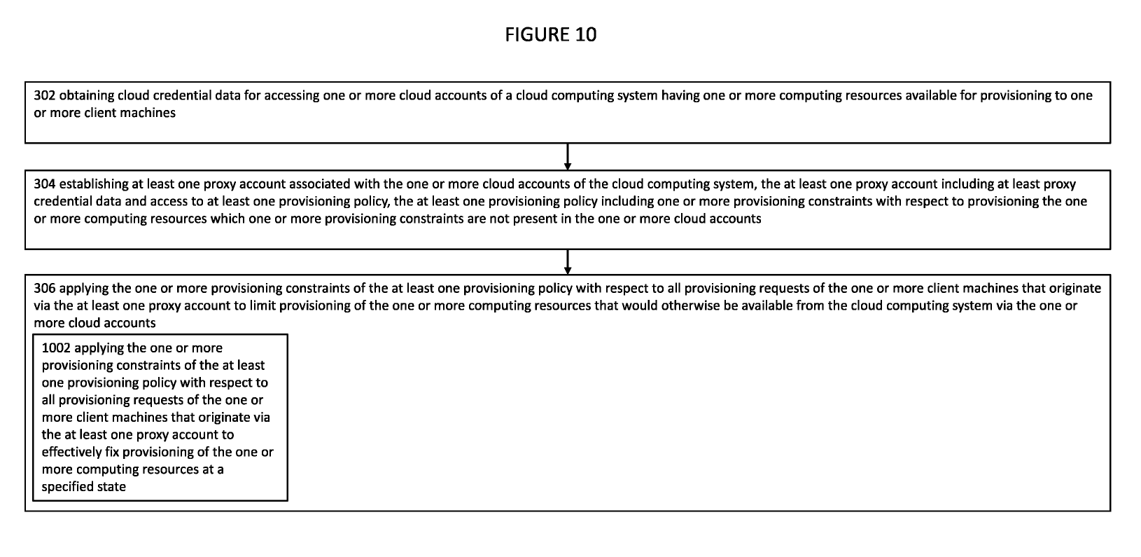

FIG. 10 is a flow diagram of computer process, in accordance with an embodiment of the invention.

In one embodiment, a computer process includes applying the one or more provisioning constraints of the at least one provisioning policy with respect to all provisioning requests of the one or more client machines that originate via the at least one proxy account to effectively fix provisioning of the one or more computing resources at a specified state at 1002.

A computer process such as an application proxy 204 in a cloud environment 200 has persisted to local storage one or more proxy accounts containing at least proxy credential data, and has persisted an association between the one or more proxy accounts and one or more cloud accounts of the cloud computing system, and has persisted an association between the one or more proxy accounts and at least one provisioning policy. In this example, requests have been sent from the one or more proxy accounts, and have provisioned one or more computing resources into the cloud computing system. A client machine, such as a customer PC or workstation 213, creates a request which is submitted to the cloud environment 200 with proxy credential data for accessing a proxy account of the cloud environment 200, the proxy account being associated with a provisioning policy which allows the associated proxy account to effectively fix provisioning of the one or more computing resources. A computer process such as an application 204 in a cloud environment 200, on receipt and validation of the request, removes the association between proxy accounts and provisioning policies which allow provisioning of computing resources into the cloud computing system, and removes the association between proxy accounts and provisioning policies which allow a change of the association of proxy accounts and provisioning policies, such that the association of proxy accounts and provisioning policies which allow provisioning of computing resources into the cloud computing system are removed but could be re-instated.

In one embodiment, all associations between proxy accounts and provisioning policies are removed, removing all authorization from all proxy accounts, and effectively fixing all provisioned computing resources, proxy accounts, and provisioning policies.

In another embodiment, all proxy accounts are removed, removing all authentication for users of proxy accounts, and effectively fixing all provisioned computing resources, proxy accounts, and provisioning policies.

In another embodiment, all cloud accounts of the cloud computing systems are removed, removing the ability for proxy accounts to provision into the cloud computing system, effectively fixing all provisioned computing resources.

In another embodiment, all cloud accounts of the cloud computing systems are removed, removing the ability for proxy accounts to effect provisioning in the cloud computing system, effectively fixing all provisioned computing resources.

In another embodiment, all associations between proxy accounts and provisioning policies which allow provisioning of computing resources into the cloud computing system are removed, but associations between proxy accounts and provisioning policies which allow a change of the association of proxy accounts and provisioning policies are not removed, effectively fixing all provisioned computing resources unless a proxy account is changed to be associated with a provisioning policy which allows provisioning of computing resources into the cloud computing system.

In another embodiment, all associations between proxy accounts and provisioning policies which allow the creation of new computing resources into the cloud computing system are removed, but associations between proxy accounts and provisioning policies which allow other provisioning actions such as administration, updates, and/or removal are not removed, effectively allowing no new computing resources to be created, but allowing administration, updates, and/or removal of previously created computing resources.

In another embodiment, all associations between proxy accounts and provisioning policies which allow provisioning of a one or more computing resources into the cloud computing system are removed, but associations between proxy accounts and provisioning policies for other computing resources are not removed, effectively fixing the provisioning of the one or more computing resources, but allowing the provisioning of other computing resources.

In another embodiment, all associations between proxy accounts and provisioning policies which allow one or more kinds of provisioning of computing resources into the cloud computing system are removed, but associations between proxy accounts and provisioning policies for other kinds of provisioning of computing resources are not removed, effectively preventing the one or more kinds of provisioning of computing resources, but allowing other kinds of provisioning of computing resources.

In another embodiment, the associations between one or more particular proxy accounts, or groups of proxy accounts, and one or more provisioning policies which allow provisioning of one more computing resources or one or more groups of computing resource, or one or more kinds of provisioning, into the cloud computing system are removed, but associations between proxy accounts and provisioning policies for other computing resources and/or types or provisioning of computing resource are not removed, effectively fixing the provisioning of one or more computing resources or types of provisioning for one or more proxy accounts or groups of proxy accounts, but allowing the provisioning of other computing resources or types or provisioning of computing resources.

For example, Alice has a proxy account associated with a provisioning policy A which allows deploying of a new web application into the cloud computing environment, and another provisioning policy S which allows starting and stopping of a web application. Zoe has a proxy account associated with a provisioning policy Z, which allows her to request that all associations between proxy accounts and provisioning policy A be removed. If Zoe submits such a request and it is processed by the application proxy, Alice will no longer be able to deploy web applications into the cloud computing environment, but will still be able to start and stop web applications.

Continuing this example, Andy has a proxy account associated with provisioning policy A. Provisioning policy Z is changed to allow Zoe to select which proxy account should have their association to policy A removed. Zoe can now submit a request specifying that only Alice's proxy account has its association to policy A removed, and Andy will still be able to deploy web applications into the cloud environment, but Alice will not.

Continuing this example, provisioning policy Y allows for the removal of associations between any proxy account and any provisioning policy which allows the deployment of any computing resource. Zoe's proxy account is associated with provisioning policy Y. Bob has a proxy account associated with provisioning policy B, which allows serverless applications to be deployed. In this example, a request from Zoe can remove the association between Bob's proxy account and provisioning policy B, and the association between Alice's proxy account and provisioning policy A, and the associated between Andy's proxy account and provisioning policy A.

Continuing this example, provisioning policy X allows for the removal of associations between proxy accounts and any provisioning policy which can alter the association between a proxy account and its provisioning policies. Carol's proxy account is associated with provisioning policy X. In this example, a request from Carol can remove the association between Zoe's proxy account and provisioning policy Z and/or Y, and can also remove her own association with provisioning policy X.

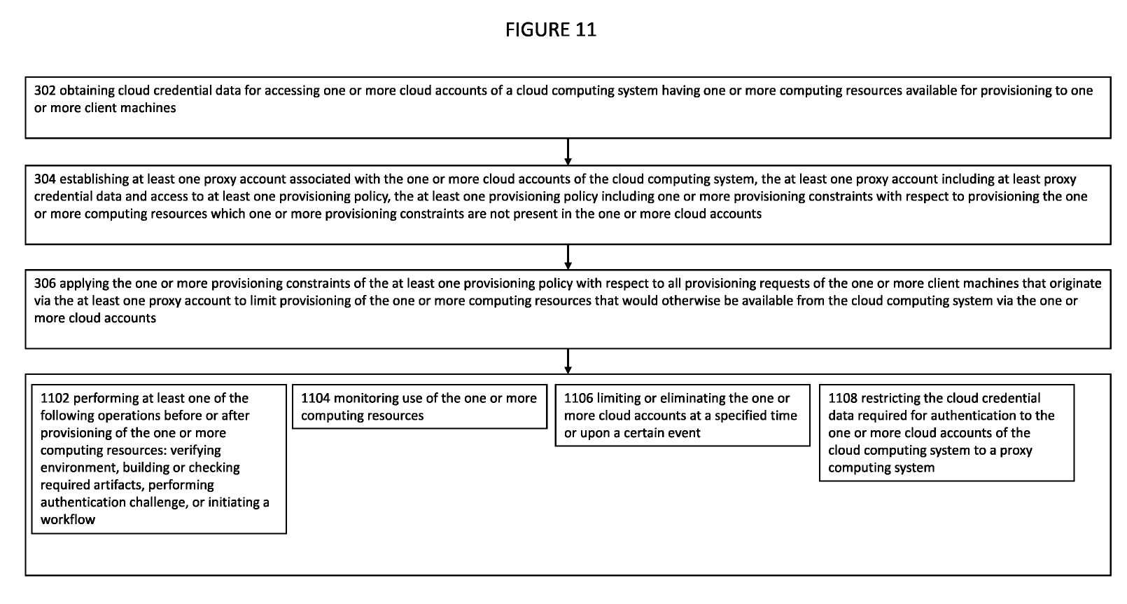

FIG. 11 is a flow diagram of computer process, in accordance with an embodiment of the invention.

In one embodiment, a computer process includes performing at least one of the following operations before or after provisioning of the one or more computing resources: verifying environment, building or checking required artifacts, performing authentication challenge, or initiating a workflow at 1102.

The application proxy for managing cloud provisioning requests 204 receives a cloud resource provisioning request submitted by the customer PC or workstation 213. The application proxy uses an access control and security module 1104, which may use a user authentication store 1105 in persistent storage, a request validation module 1106 using a cloud resource provisioning policy store 1107, and other local or external data stores or APIs as required, to examine the request for validity, requirements for provisioning, and actions required before and/or after provisioning. The cloud resource provisioning API 1111, and other local or external data stores or APIs as required, are used to determine the state of the cloud computing system against requirements, to determine the state of artifacts against requirements, and/or to perform actions.

In one embodiment, the provisioning policy associated with a proxy account may require that the cloud computing environment within which a computing resource is to be provisioned fulfils certain criteria before or after the provisioning of the resource. For example, the cloud computing environment may be required to have minimum, maximum, particular or a range of available CPU, RAM or persistent storage, network capabilities, existing artifacts, or hardware, platform, container, or application as a service capabilities.

In another embodiment, the provisioning policy associated with a proxy account may require that the artifact which is to be provisioned fulfils certain criteria before or after the provisioning of the resource. For example, the artifact may undergo static or dynamic analysis to ensure the absence of security vulnerabilities, viruses, macros, technology components, proprietary or sensitive information, or other attributes which would cause the artifact to be rejected. In another example, the artifact may undergo static or dynamic analysis to ensure the absence of security checks digital signatures, provenance, technology components, proprietary or sensitive information, or other attributes which would cause the artifact to be accepted.

In another embodiment, the provisioning policy associated with a proxy account may require that the artifact which is to be provisioned undergoes transformations before or after the provisioning of the resource. For example, the artifact may be source code which requires compilation, a template which requires information to be added, a declarative document which requires translation into executable code, or other kind of artifact which requires addition, removal, or change to be ready for provisioning into the cloud computing system.

In another embodiment, the provisioning policy associated with a proxy account may require that an authentication challenge be issued and passed before a resource is provisioning into the cloud computing system. The authentication challenge may as a second factor authentication to the requesting proxy account, or one or more proxy accounts specified in the provisioning policy.

In another embodiment, the provisioning policy associated with a proxy account may require that a workflow be initiated before and/or after a resource is provisioning into the cloud computing system.

In another embodiment, the provisioning policy associated with a proxy account may require a combination of the above.

For example, a user sends a request, authorized by the credentials of a proxy account, to an application proxy which manages cloud provisioning requests. The provisioning policy requires that the request contain a digitally signature from a whitelisted certification authority, and the URI of a code repository from a whitelist of approved code repositories. The code is downloaded from the repository, checked for sensitive information such as usernames or passwords, and compiled using the instructions in the code's build properties. The compiled artifact is then provisioned into the cloud computing system, and a workflow initiated to schedule the removal of the artifact at a date in the future.

In one embodiment, a computer process includes monitoring use of the one or more computing resources at 1104.

The application proxy for managing cloud provisioning requests 204 receives a cloud resource provisioning request submitted by the customer PC or workstation 213. The request contains credential data for a proxy account, and a provisioning policy associated with a proxy account may require the monitoring of one or more computing resource, in a cloud computing system or elsewhere, using system commands, or local or remote API such as the cloud resource provisioning API 1111.

In one embodiment, the request contains information of the resources and the attributes to be monitored, and actions to take under particular circumstances.

In another embodiment, the provisioning policy contains information of the resources and the attributes to be monitored, and actions to take under particular circumstances.

In another embodiment, system or application defaults contain information of the resources and the attributes to be monitored, and actions to take under particular circumstances.

In another embodiment, information of the resources and the attributes to be monitored, and actions to take under particular circumstances are derived from a combination of information from the request, provisioning policy, system or application defaults, or other local or remote data stores or APIs.

For example, user may request for a resource to be started in the cloud computing system. The provisioning policy associated with the proxy account, which grants this request, may also require that the resource be monitored for its CPU usage, and a notification sent to the user if a limit is reached.

In one embodiment, a computer process includes limiting or eliminating the one or more cloud accounts at a specified time or upon a certain event at 1106.

The application proxy for managing cloud provisioning requests 204 receives a cloud resource provisioning request submitted by the customer PC or workstation 213. The request contains credential data for a proxy account, and a provisioning policy associated with a proxy account may allow the request to limit or eliminate one or more cloud accounts, in a cloud computing system or elsewhere, using system commands, or local or remote API such as the cloud account provisioning APIs 210.

In one embodiment, a user sends the request to limit or eliminate one or more cloud accounts, in a cloud computing system or elsewhere.

In another embodiment, the a provisioning policy associated with a user account sends the request to limit or eliminate one or more cloud accounts, in a cloud computing system or elsewhere.

In another embodiment, a workflow initiated by a user request, as part of a provisioning policy, or other means, sends the request to limit or eliminate one or more cloud accounts, in a cloud computing system or elsewhere.

For example, a user requests that a resource be provisioning into a cloud computing system. The provisioning policy associated with the proxy account submitting the request specifies that this resource may be provisioning only once, and afterwards no more resources may be provisioned onto the cloud computing system. After provisioning the resource into the cloud environment, all cloud account for the cloud environment are deleted using the cloud account provisioning API, making it impossible to provision further resources onto the cloud environment.

In one embodiment, a computer process includes restricting the cloud credential data required for authentication to the one or more cloud accounts of the cloud computing system to a proxy computing system at 1108.

A proxy computing system, such as an application proxy for managing cloud provisioning requests 204, writes to persistent storage credential data for one or more cloud accounts of the cloud computing system. Using the cloud account provisioning APIs 210, the application proxy determines or ensures that all other credential data for cloud accounts of the cloud computing system are invalidated.

In one embodiment, the application proxy is installed onto a cloud environment with no existing cloud accounts.

In another embodiment, the application proxy, using the cloud account provisioning APIs, resets the password of existing cloud accounts, intercepting the passwords generated and saving them to persistent storage, with access to the passwords restricted to the application proxy.

In another embodiment, the application proxy, using the cloud account provisioning APIs, deactivates existing cloud accounts.

In another embodiment, the application proxy, using the cloud account provisioning APIs, creates new cloud accounts, intercepting the passwords generated and saving them to persistent storage, with access to the passwords restricted to the application proxy.

In another embodiment, credential data for one or more cloud accounts is accessible to other processes or applications which may also associate the cloud accounts with provisioning policies, to restrict the actions of associated proxy accounts, or may have other means of restricting, controlling, managing, or monitoring the use of the cloud account or the credential data for the cloud account.

For example, an application proxy is installed into a cloud computing environment. The application proxy creates a subscription on a cloud computing system, receiving a cloud account for the cloud computing system with credential data, which is persisted to local storage and accessible only to the application proxy. The application proxy, using the cloud account provisioning APIs, creates one or more cloud accounts, credential data for which are persisted to local storage and accessible only to the application proxy to be associated with future provisioning policies. ensuring that all resource provisioning on the cloud environment requires a proxy account associated with one or more provisioning policies and the one or more cloud accounts created by the application proxy.

In another example, an application proxy is installed into a cloud computing environment. The application proxy, using the cloud account provisioning APIs, creates one or more cloud account to be associated with future provisioning policies, and then removes, disables, or otherwise renders unusable, all other cloud accounts using the cloud account provisioning APIs, ensuring that all resource provisioning on the cloud environment requires a proxy account associated with one or more provisioning policies and the one or more cloud accounts created by the application proxy.

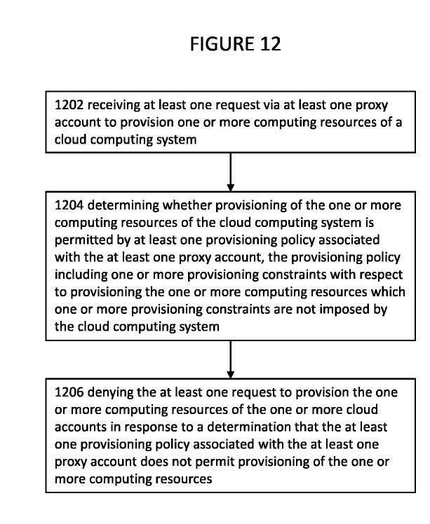

FIG. 12 is a flow diagram of computer process, in accordance with an embodiment of the invention. In one embodiment, a computer process includes receiving at least one request via at least one proxy account to provision one or more computing resources of a cloud computing system at 1202.

The application proxy for managing cloud provisioning requests 204 receives request to provision one or more computing resources of a cloud computing system at 1202, submitted by the customer PC or workstation 213. The request contains credential data for a proxy account, which the application proxy checks against a user authentication store 1105 in persistent storage, to authenticate the proxy account.

In one embodiment, a computer process such as an application proxy has persisted to storage the credential data for one or more proxy accounts. Requests to the application proxy may contain credential data for a proxy account and instructions on the provisioning of one or more computing resources of a cloud computing system. The application proxy may use the credential data in the request to authenticate the request as a request from a proxy account.

For example, a user at a computer enters the username and password of a proxy account, and details of a web application computing resource to be provisioned, which may include a number of virtual CPUs, RAM and persistent storage to be provided, a web application server to be installed, and a web application to be run on the web application server. It may also include details of a database to be provisioned, which may include a number of virtual CPUs, RAM and persistent storage to be provided, the database server to be installed, and details of applications and/or users authorised to read and write to the database. The data is sent in a request to the API provided by an application proxy, which authenticates the request by validating the username and password against usernames and passwords on persistent storage, and if the request is validated, processes the provisioning request.

In one embodiment, a computer process includes determining whether provisioning of the one or more computing resources of the cloud computing system is permitted by at least one provisioning policy associated with the at least one proxy account, the provisioning policy including one or more provisioning constraints with respect to provisioning the one or more computing resources which one or more provisioning constraints are not imposed by the cloud computing system at 1204.

The application proxy for managing cloud provisioning requests 204 receives a cloud resource provisioning request submitted by the customer PC or workstation 213. The request contains credential data for a proxy account, which the application proxy checks against a user authentication store 1105 in persistent storage, to authenticate the proxy account. The proxy account is associated with at least one provisioning policy in the cloud resource provisioning policy store 1110. Each provisioning policy in the provisioning policy store may contain one or more provisioning constraints, which can be applied against the provisioning request, to determine the request's validity and whether to provision the one or more requested computing resources into the cloud computing system.

The provisioning of resources may be specified according to a formatted file (in YAML, XML, or similar) and/or a script describing the actions to be taken, according to the requirements of the cloud provisioning API of the cloud computing system. A computer process can compare this specification for resource provisioning against the constraints in the provisioning policy to ensure that the provisioning is permitted.

For example, the cloud provisioning API of the cloud computing system may accept a template describing the resource to be provisioned which includes a list of network ports and protocols that the deployed resource wishes to use. A constraint in a provisioning policy may contains a whitelist and/or a blacklist of ports and protocols, which a computer process can check against the request.

Also, the provisioning of resources may be specified according to a formatted file (in YAML, XML, or similar) and/or a script describing the actions to be taken, according to the requirements of an API published by a proxy application, which may be installed on the cloud computing system. A computer process can compare this specification for resource provisioning against the constraints in the provisioning policy to ensure that the provisioning is permitted.

For example, a proxy application API may accept a URI which contains source code, and instructions for building the source code. A constraint in a provisioning policy may contains a whitelist and/or a blacklist of URIs, which a computer process can check against the request.

In another example, a provisioning policy may contain the constraint that requests containing the location of a GITHUB repository from which to source an application must be one of the GitHub repositories specified in the constraint. The URI in the request is compared to the list of GITHUB repositories to determine if the provisioning is permitted.

In another example, a provisioning policy may contain a constraint with a maximum allocation for provisioned resources, which may be a maximum of CPUs, vCPUs, RAM, persistent storage, instances, availability, or another attribute of the application, deployment, or environment. If the request specifies more than the maximum, then the constraint may specify that the request should be rejected, the maximum applied instead of the requested, the request be accepted dependent on subsequent confirmation, or a workflow initiated.

In one embodiment, a computer process includes denying the at least one request to provision the one or more computing resources of the one or more cloud accounts in response to a determination that the at least one provisioning policy associated with the at least one proxy account does not permit provisioning of the one or more computing resources at 1206.

The application proxy for managing cloud provisioning requests 204, determining that one or more provisioning constraints in a provisioning policy in the provisioning policy store are not meet by a provisioning request from a proxy account associated with this provisioning policy, denies the request and does not action the provisioning request.

In one embodiment, the denial of the request is silent, and the user who submitted the provisioning request is not informed of the failure of the request to meet the relevant provisioning constraints.

In another embodiment, the user who submitted the provisioning request is informed of the failure of the request to meet the relevant provisioning constraints, and may additionally in some embodiments be informed of which constraints and/or features of the request caused the failure.

In another embodiment, the provisioning policy contains actions to be taken in the event of provisioning constraints in the provisioning policy not being met by the provisioning request. Such actions may include notifying one or more users or disabling the proxy account.

In another embodiment, the provisioning policy contains actions to be taken in the event of provisioning constraints in the provisioning policy being met by the provisioning request, and if these actions cannot be completed or fail, in which case the provisioning request is not actioned. Such actions may include receiving additional authorization, fulfilment of a workflow, or a call to a local or remote API.

For example, a provisioning policy contains a provisioning constraint restricting deployments to only serverless applications, from a specified GitHub repository. The constraint further specifies a list of email addresses to notify in case a request is denied. If a request is received requesting the deployment of another type of application, and/or an application sourced from a location other than the specified GitHub repository, then the request is denied, and an email is sent to each of the specified email addresses.

In another example, a provisioning policy contains a provisioning constraint specifying that a notification is sent to one or more other proxy accounts that additional authorization is required, and this authorisation must be received from the other one or more proxy accounts within a certain timeframe. If the notification cannot be sent, or if these one or more authorisation are not received, then the request is denied.

While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

What is claimed is:

1. A computer process for interacting with a cloud computing system having one or more computing resources available for provisioning to one or more client machines to increase data security, the computer process comprising:
obtaining cloud credential data for accessing one or more cloud accounts of a cloud computing system having one or more computing resources available for provisioning to one or more client machines;
establishing at least one proxy account associated with the one or more cloud accounts of the cloud computing system, the at least one proxy account including at least proxy credential data and access to at least one provisioning policy, the at least one provisioning policy including one or more provisioning constraints with respect to provisioning the one or more computing resources which one or more provisioning constraints are not present in the one or more cloud accounts; and
applying the one or more provisioning constraints of the at least one provisioning policy with respect to all provisioning requests of the one or more client machines that originate via the at least one proxy account to limit provisioning of the one or more computing resources that would otherwise be available from the cloud computing system via the one or more cloud accounts.

2. The computer process of claim 1, wherein the computer process executed by the cloud computing system.

3. The computer process of claim 1, wherein the computer process is executed by a proxy computing system.

4. The computer process of claim 1, wherein the obtaining cloud credential data for accessing one or more cloud accounts of a cloud computing system having one or more computing resources available for provisioning to one or more client machines comprises:
obtaining from user input cloud credential data for accessing one or more cloud accounts of a cloud computing system having one or more computing resources available for provisioning to one or more client machines.

5. The computer process of claim 1, wherein the obtaining cloud credential data for accessing one or more cloud accounts of a cloud computing system having one or more computing resources available for provisioning to one or more client machines comprises:
obtaining electronically cloud credential data for accessing one or more cloud accounts of a cloud computing system having one or more computing resources available for provisioning to one or more client machines.

6. The computer process of claim 1, wherein the obtaining cloud credential data for accessing one or more cloud accounts of a cloud computing system having one or more computing resources available for provisioning to one or more client machines comprises:
obtaining cloud credential data that includes at least one of the following types of authentication data for accessing one or more cloud accounts of a cloud computing system having one or more computing resources available for provisioning to one or more client machines: username, password, Public Key infrastructure (PKI) certificate, RSA token, biometric information, or a combination of any of the foregoing.

7. The computer process of claim 1, wherein the obtaining cloud credential data for accessing one or more cloud accounts of a cloud computing system having one or more computing resources available for provisioning to one or more client machines comprises:
obtaining cloud credential data for accessing one or more cloud accounts of a cloud computing system having one or more of the following types of computing resources available for provisioning to one or more client machines: hardware, virtual machine, storage, internet connectivity, software application, a database, a web application, network, application, service, container, or script.

8. The computer process of claim 1, wherein the obtaining cloud credential data for accessing one or more cloud accounts of a cloud computing system having one or more computing resources available for provisioning to one or more client machines comprises:
obtaining cloud credential data for accessing one or more cloud accounts of a cloud computing system having one or more computing resources available for granting access to one or more client machines.

9. The computer process of claim 1, wherein the obtaining cloud credential data for accessing one or more cloud accounts of a cloud computing system having one or more computing resources available for provisioning to one or more client machines comprises:
obtaining cloud credential data for accessing one or more cloud accounts of a cloud computing system having one or more computing resources available for provisioning to one or more of the following types of client machines: mobile phone, computer, tablet, virtual reality glasses, wearable, or server.

10. The computer process of claim 1, wherein the establishing at least one proxy account associated with the one or more cloud accounts of the cloud computing system, the at least one proxy account including at least proxy credential data and access to at least one provisioning policy, the at least one provisioning policy including one or more provisioning constraints with respect to provisioning the one or more computing resources which one or more provisioning constraints are not present in the one or more cloud accounts comprises:
obtaining access to at least one proxy account associated with the one or more cloud accounts of the cloud computing system, the at least one proxy account including at least proxy credential data and access to at least one provisioning policy, the at least one provisioning policy including one or more provisioning constraints with respect to provisioning the one or more computing resources which one or more provisioning constraints are not present in the one or more cloud accounts.

11. The computer process of claim 1, wherein the establishing at least one proxy account associated with the one or more cloud accounts of the cloud computing system, the at least one proxy account including at least proxy credential data and access to at least one provisioning policy, the at least one provisioning policy including one or more provisioning constraints with respect to provisioning the one or more computing resources which one or more provisioning constraints are not present in the one or more cloud accounts comprises:
creating at least one proxy account associated with the one or more cloud accounts of the cloud computing system, the at least one proxy account including at least proxy credential data and access to at least one provisioning policy, the at least one provisioning policy including one or more provisioning constraints with respect to provisioning the one or more computing resources which one or more provisioning constraints are not present in the one or more cloud accounts.

12. The computer process of claim 1, wherein the establishing at least one proxy account associated with the one or more cloud accounts of the cloud computing system, the at least one proxy account including at least proxy credential data and access to at least one provisioning policy, the at least one provisioning policy including one or more provisioning constraints with respect to provisioning the one or more computing resources which one or more provisioning constraints are not present in the one or more cloud accounts comprises:
receiving input identifying at least one proxy account associated with the one or more cloud accounts of the cloud computing system, the at least one proxy account including at least proxy credential data and access to at least one provisioning policy, the at least one provisioning policy including one or more provisioning constraints with respect to provisioning the one or more computing resources which one or more provisioning constraints are not present in the one or more cloud accounts.

13. The computer process of claim 1, wherein the establishing at least one proxy account associated with the one or more cloud accounts of the cloud computing system, the at least one proxy account including at least proxy credential data and access to at least one provisioning policy, the at least one provisioning policy including one or more provisioning constraints with respect to provisioning the one or more computing resources which one or more provisioning constraints are not present in the one or more cloud accounts comprises:
establishing by the cloud computing system at least one proxy account associated with the one or more cloud accounts of the cloud computing system, the at least one proxy account including at least proxy credential data and access to at least one provisioning policy, the at least one provisioning policy including one or more provisioning constraints with respect to provisioning the one or more computing resources which one or more provisioning constraints are not present in the one or more cloud accounts.

14. The computer process of claim 1, wherein the establishing at least one proxy account associated with the one or more cloud accounts of the cloud computing system, the at least one proxy account including at least proxy credential data and access to at least one provisioning policy, the at least one provisioning policy including one or more provisioning constraints with respect to provisioning the one or more computing resources which one or more provisioning constraints are not present in the one or more cloud accounts comprises:
establishing by at least one proxy system at least one proxy account associated with the one or more cloud accounts of the cloud computing system, the at least one proxy account including at least proxy credential data and access to at least one provisioning policy, the at least one provisioning policy including one or more provisioning constraints with respect to provisioning the one or more computing resources which one or more provisioning constraints are not present in the one or more cloud accounts.

15. The computer process of claim 1, wherein the establishing at least one proxy account associated with the one or more cloud accounts of the cloud computing system, the at least one proxy account including at least proxy credential data and access to at least one provisioning policy, the at least one provisioning policy including one or more provisioning constraints with respect to provisioning the one or more computing resources which one or more provisioning constraints are not present in the one or more cloud accounts comprises:
establishing at least one proxy account associated with the one or more cloud accounts of the cloud computing system, the at least one proxy account including proxy credential data that includes at least one of the following types of authentication data: username, password, Public Key Infrastructure (PKI) certificate, RSA token, biometric information, or a combination of any of the foregoing.

16. The computer process of claim 1, wherein the establishing at least one proxy account associated with the one or more cloud accounts of the cloud computing system, the at least one proxy account including at least proxy credential data and access to at least one provisioning policy, the at least one provisioning policy including one or more provisioning constraints with respect to provisioning the one or more computing resources which one or more provisioning constraints are not present in the one or more cloud accounts comprises:
establishing at least one proxy account associated with the one or more cloud accounts of the cloud computing system, the at least one proxy account including at least proxy credential data and access to at least one provisioning policy, the at least one provisioning policy including one or more of the following types of provisioning constraints with respect to provisioning the one or more computing resources: creating resource, maintaining resource, starting resource, stopping resource, increasing resource, decreasing resource, or deletion of resource.

17. The computer process of claim 1, wherein the establishing at least one proxy account associated with the one or more cloud accounts of the cloud computing system, the at least one proxy account including at least proxy credential data and access to at least one provisioning policy, the at least one provisioning policy including one or more provisioning constraints with respect to provisioning the one or more computing resources which one or more provisioning constraints are not present in the one or more cloud accounts comprises:
establishing at least one proxy account associated with the one or more cloud accounts of the cloud computing system, the at least one proxy account including at least proxy credential data and access to at least one provisioning policy, the at least one provisioning policy including one or more of the following types of provisioning constraints with respect to provisioning the one or more computing resources: permitted, denied, authorized, conditioned, authenticated, or dependent.

18. The computer process of claim 1, wherein the establishing at least one proxy account associated with the one or more cloud accounts of the cloud computing system, the at least one proxy account including at least proxy credential data and access to at least one provisioning policy, the at least one provisioning policy including one or more provisioning constraints with respect to provisioning the one or more computing resources which one or more provisioning constraints are not present in the one or more cloud accounts comprises:
establishing at least one proxy account associated with the one or more cloud accounts of the cloud computing system, the at least one proxy account including at least proxy credential data and access to at least one provisioning policy, the at least one provisioning policy including one or more of the following types of provisioning constraints with respect to provisioning the one or more computing resources: work flow requirement, multiple account approval requirement, provenance requirement, static analysis requirement, network capability requirement, resource relationship, use requirement, action trigger requirement, prior provisioning requirement.

19. The computer process of claim 1, wherein the establishing at least one proxy account associated with the one or more cloud accounts of the cloud computing system, the at least one proxy account including at least proxy credential data and access to at least one provisioning policy, the at least one provisioning policy including one or more provisioning constraints with respect to provisioning the one or more computing resources which one or more provisioning constraints are not present in the one or more cloud accounts comprises:
establishing at least one proxy account associated with the one or more cloud accounts of the cloud computing system, the at least one proxy account including at least proxy credential data and access to at least one provisioning policy, the at least one provisioning policy including one or more provisioning modification constraints with respect to changing the at least one provisioning policy.

20. The computer process of claim 1, wherein the establishing at least one proxy account associated with the one or more cloud accounts of the cloud computing system, the at least one proxy account including at least proxy credential data and access to at least one provisioning policy, the at least one provisioning policy including one or more provisioning constraints with respect to provisioning the one or more computing resources which one or more provisioning constraints are not present in the one or more cloud accounts comprises:
establishing at least one proxy account associated with the one or more cloud accounts of the cloud computing system, the at least one proxy account including at least proxy credential data and access to at least one provisioning policy that includes any of the following: declarative statement, script, compiled code, executable code, or template.

21. The computer process of claim 1, wherein the establishing at least one proxy account associated with the one or more cloud accounts of the cloud computing system, the at least one proxy account including at least proxy credential data and access to at least one provisioning policy, the at least one provisioning policy including one or more provisioning constraints with respect to provisioning the one or more computing resources which one or more provisioning constraints are not present in the one or more cloud accounts comprises:
establishing at least one proxy account associated with the one or more cloud accounts of the cloud computing system, the at least one proxy account including at least proxy credential data and access to at least one provisioning policy, the at least one provisioning policy including one or more of the following administration features: enable proxy account, disable proxy account, create proxy account, suspend proxy account, or unsuspend proxy account.

22. The computer process of claim 1, wherein the establishing at least one proxy account associated with the one or more cloud accounts of the cloud computing system, the at least one proxy account including at least proxy credential data and access to at least one provisioning policy, the at least one provisioning policy including one or more provisioning constraints with respect to provisioning the one or more computing resources which one or more provisioning constraints are not present in the one or more cloud accounts comprises:
establishing at least one proxy account associated with the one or more cloud accounts of the cloud computing system, the at least one proxy account including at least proxy credential data and access to at least one provisioning policy, the at least one provisioning policy including one or more provisioning constraints with respect to provisioning the one or more computing resources statically, dynamically, as an end-user service, or just-in-time.

23. The computer process of claim 1, wherein the establishing at least one proxy account associated with the one or more cloud accounts of the cloud computing system, the at least one proxy account including at least proxy credential data and access to at least one provisioning policy, the at least one provisioning policy including one or more provisioning constraints with respect to provisioning the one or more computing resources which one or more provisioning constraints are not present in the one or more cloud accounts comprises:
establishing a plurality of proxy accounts associated with the one or more cloud accounts of the cloud computing system, each of the plurality of proxy accounts including different proxy credential data and access to different provisioning policies.

24. The computer process of claim 1, wherein the applying the one or more provisioning constraints of the at least one provisioning policy with respect to all provisioning requests of the one or more client machines that originate via the at least one proxy account to limit provisioning of the one or more computing resources that would otherwise be available from the cloud computing system via the one or more cloud accounts comprises:
applying the one or more provisioning constraints of the at least one provisioning policy with respect to all provisioning requests of the one or more client machines that originate via the at least one proxy account to effectively fix provisioning of the one or more computing resources at a specified state.

25. The computer process of claim 1, further comprising:
performing at least one of the following operations before or after provisioning of the one or more computing resources: verifying environment, building or checking required artifacts, performing authentication challenge, or initiating a workflow.

26. The computer process of claim 1, further comprising:
monitoring use of the one or more computing resources.

27. The computer process of claim 1, further comprising:
limiting or eliminating the one or more cloud accounts at a specified time or upon a certain event.

28. The computer process of claim 1, further comprising:
restricting the cloud credential data required for authentication to the one or more cloud accounts of the cloud computing system to a proxy computing system.

29. A computer process for interacting with a cloud computing system having one or more computing resources available for provisioning to one or more client machines to increase data security, the computer process comprising:
receiving at least one request via at least one proxy account to provision one or more computing resources of a cloud computing system;
determining whether provisioning of the one or more computing resources of the cloud computing system is permitted by at least one provisioning policy associated with the at least one proxy account, the provisioning policy including one or more provisioning constraints with respect to provisioning the one or more computing resources which one or more provisioning constraints are not imposed by the cloud computing system; and
denying the at least one request to provision the one or more computing resources of the one or more cloud accounts in response to a determination that the at least one provisioning policy associated with the at least one proxy account does not permit provisioning of the one or more computing resources.

30. A system that increases security of data in a cloud computing environment, the system comprising:
a cloud computing system having one or more computing resources available for provisioning to one or more client machines via one or more cloud accounts; and
a proxy computing system that is communicably linked to the cloud computing system, the proxy computing system including
memory bearing one or more computer executable instructions; and
at least one processing device operably coupled to the memory and configured to implement the one or more computer executable instructions to perform operations comprising:
establishing at least one proxy account associated with the one or more cloud accounts of the cloud computing system, the at least one proxy account including at least proxy credential data and access to at least one provisioning policy, the at least one provisioning policy including one or more provisioning constraints with respect to provisioning the one or more computing resources which one or more provisioning constraints are not present in the one or more cloud accounts; and
applying the one or more provisioning constraints of the at least one provisioning policy with respect to all provisioning requests of the one or more client machines that originate via the at least one proxy account to limit provisioning of the one or more computing resources of the one or more cloud accounts that would otherwise be available from the cloud computing system.
